(19) United States
(12) Patent Application Publication
(10) Pub. No.: US 2017/0149915 A1
(43) Pub. Date: May 25, 2017

(54) SYSTEM AND METHOD OF FEED DATA TRANSMISSION

(71) Applicant: SAP SE, Walldorf (DE)

(72) Inventor: Masoud Aghadavoodi Jolfaei, Wiesloch (DE)

(21) Appl. No.: 14/952,018

(22) Filed: Nov. 25, 2015

(51) Int. Cl. H04L 29/08

(52) U.S. Cl. CPC H04L 67/26; H04L 67/02; H04L 67/10

(57) ABSTRACT

In some example embodiments, a method comprises: receiving first feed data from a first feed source; generating a first message based on the first feed data and a messaging protocol, the first message comprising the first feed data and first context information indicating an application; transmitting the first message to a component dispatcher via a first WebSocket connection, the component dispatcher being configured to transmit the first feed data to the application based on the first context information; receiving second feed data from a second feed source; generating a second message based on the second feed data and the messaging protocol, the second message comprising the second feed data and second context information indicating the application; and transmitting the second message to the component dispatcher via the first WebSocket connection, the component dispatcher being configured to transmit the second feed data to the application based on the second context information.

### TECHNICAL FIELD

The present application relates generally to the technical field of data processing, and, in various embodiments, to systems and methods of feed data transmission.

### BACKGROUND

Software enterprise applications involve the consumption of push events in real-time occurring in enterprise systems. Such consumption involves notifying a user interface (UI) application about the changes to objects that are accessed and displayed in the UI application (e.g., SAP Fiori in SAPUI 5, Web Dynpro, WebGUI). The notification can be used for various scenarios, such as to read the new data from a back-end system and to automatically refresh the corresponding UI elements and screen. Additionally, in some situations, important alerts or messages can be displayed without any corresponding user interaction, collaborative viewing, or instant editing of shared documents. Finally, depending on the end-user's role, the software applications can comprise different UI areas consuming various back-end push events in the form of data feeds. A data feed is a mechanism used to receive updated data from one or more data sources.

### BRIEF DESCRIPTION OF THE DRAWINGS

Some example embodiments of the present disclosure are illustrated by way of example and not limitation in the figures of the accompanying drawings, in which like reference numbers indicate similar elements, and in which:

FIG. 1 is a network diagram illustrating a client-server system, in accordance with some example embodiments;

FIG. 2 is a block diagram illustrating enterprise applications and services in an enterprise application platform, in accordance with some example embodiments;

FIG. 3 is a block diagram illustrating a feed services system, in accordance with some example embodiments;

FIG. 4 is a block diagram illustrating communication sessions of a feed services system, in accordance with some example embodiments;

FIG. 5 illustrates a graphical user interface displaying a visualization of feed data being used by a business application, in accordance with some example embodiments;

FIG. 6 illustrates a graphical user interface displaying another visualization of feed data being used by a business application, in accordance with some example embodiments;

FIG. 7 is a table of messaging protocol fields, in accordance with some example embodiments;

FIG. 8 is a description of a message of the messaging protocol using the Backus-Naur Form (BNF) grammar, in accordance with some example embodiments;

FIG. 9 is a flowchart illustrating a method of providing feed services, in accordance with some example embodiments;

FIGS. 10A-10C illustrate a WebSocket multiplexing interaction model using the messaging protocol, in accordance with some example embodiments;

FIG. 11 illustrates a process flow for a technical WebSocket connection setup, in accordance with some example embodiments;

FIGS. 12A-12D illustrate a process flow for a logical WebSocket connection setup, in accordance with some example embodiments;

FIGS. 13A-13C illustrate a process flow for handling of a WebSocket send on a logical WebSocket connection, in accordance with some example embodiments;

FIGS. 14A-14C illustrate a process flow for handling of a WebSocket close for a logical WebSocket connection, in accordance with some example embodiments;

FIGS. 15A-15B illustrate a process flow for handling of a WebSocket close for a technical WebSocket connection, in accordance with some example embodiments;

FIGS. 16A-16 illustrate a process flow for handling of an Advanced Business Application Programming (ABAP) Messaging Channel (AMC) send to a logical WebSocket connection, in accordance with some example embodiments;

FIG. 17 illustrates a process flow for handling of an ABAP Push Channel (APC) send based on an APC attach handle to a logical WebSocket connection, in accordance with some example embodiments;

FIG. 18 is a block diagram illustrating a mobile device, in accordance with some example embodiments; and

FIG. 19 is a block diagram of an example computer system on which methodologies described herein can be executed, in accordance with some example embodiments.

### DETAILED DESCRIPTION

Example methods and systems of feed data transmission are disclosed. In the following description, for purposes of explanation, numerous specific details are set forth in order to provide a thorough understanding of example embodiments. It will be evident, however, to one skilled in the art that the present embodiments can be practiced without these specific details.

The present disclosure provides a technical solution for WebSocket multiplexing using a single messaging protocol to tunnel WebSocket connections on a single technical WebSocket connection for multiple feeds. This technical solution provides several technical advantages. For example, this solution will avoid costly creation of parallel WebSocket connections per feed, which is a limited resource at both sides of the communication end point (e.g., at the client and at the server). The present disclosure provides other technical advantages as well.

The present disclosure provides a messaging protocol for sending messages with context information and metadata (e.g., a content type (XML, JSON, binary)). Since applications that use WebSockets are usually interested in a number of push services. The present disclosure provides a server that is configured to send different push messages to the application's user interface (UI) via the same WebSocket connection. In order to distinguish messages from different push services, the messages contain context information in a well-defined format.

However, in contrast to HTTP messages, WebSocket messages do not provide a data structure (e.g., header fields) that can be used to transmit context information and metadata. But the WebSocket protocol supports subprotocols, which can provide a data structure to embed such information. The messaging protocol of the present disclosure provides a message structure that is very similar to a simple HTTP message, but that enables a server to send different push messages to an application's UI via the same WebSocket connection.

The messaging protocol of the present disclosure offers a common structure for push messages across multiple different applications, making it easier to understand and reuse program code and simplifying the integration of other solutions and technologies. Additionally, context information can be used to offer different push services via the same WebSocket connection. Furthermore, context information and metadata offer an easy way to keep the application-specific communication protocol extensible while preserving downward compatibility.

In some example embodiments, a computer-implemented method comprises: receiving first feed data from a first feed source; generating a first message based on the first feed data and a messaging protocol, the first message comprising the first feed data and first context information, the first context information being generated according to the messaging protocol and indicating a first application on a first computing device; transmitting the first message to a first component dispatcher on the first computing device via a first WebSocket connection, the first component dispatcher being configured to transmit the first feed data to the first application based on the first context information; receiving second feed data from a second feed source; generating a second message based on the second feed data and the messaging protocol, the second message comprising the second feed data and second context information, the second context information being generated according to the messaging protocol and indicating the first application on the first computing device; and transmitting the second message to the first component dispatcher via the first WebSocket connection, the first component dispatcher being configured to transmit the second feed data to the first application based on the second context information.

In some example embodiments, the computer-implemented method further comprises: generating a third message based on the first feed data and the messaging protocol, the third message comprising the first feed data and third context information, the third context information being generated according to the messaging protocol and indicating a second application on a second computing device; and transmitting the third message to a second component dispatcher on the second computing device via a second WebSocket connection, the second component dispatcher being configured to transmit the first feed data of the third message to the second application on the second computing device based on the third context information.

In some example embodiments, the computer-implemented method further comprises: generating a fourth message based on the first feed data and the messaging protocol, the fourth message comprising the first feed data and fourth context information, the fourth context information being generated according to the messaging protocol and indicating a third application on the first computing device; and transmitting the fourth message to the first component dispatcher on the first computing device via the first WebSocket connection, the first component dispatcher being configured to transmit the first feed data of the fourth message to the third application on the first computing device based on the fourth context information.

In some example embodiments, the computer-implemented method further comprises: receiving third feed data from the first feed source; generating a fifth message based on the third feed data and the messaging protocol, the fifth message comprising the third feed data and fifth context information, the fifth context information being generated according to the messaging protocol and indicating the first application on the first computing device; and transmitting the fifth message to the first component dispatcher on the first computing device via the first WebSocket connection, the first component dispatcher being configured to transmit the third feed data of the fifth message to the first application on the first computing device based on the fifth context information.

In some example embodiments, the first message and the second message each being without a Hypertext Transfer Protocol (HTTP) start-line.

In some example embodiments, the WebSocket connection comprises an Advanced Business Application Programming (ABAP) push channel connection.

In some example embodiments, the first context information indicates a first user interface area of the first application corresponding to a first business object, with the first feed data being used to update the first user interface area of the first application, and the second context information indicates a second user interface area of the first application corresponding to a second business object, with the second feed data being used to update the second user interface area of the first application.

The methods or embodiments disclosed herein may be implemented as a computer system having one or more modules (e.g., hardware modules or software modules). Such modules may be executed by one or more processors of the computer system. In some example embodiments, a non-transitory machine-readable storage device can store a set of instructions that, when executed by at least one processor, causes the at least one processor to perform the operations and method steps discussed within the present disclosure.

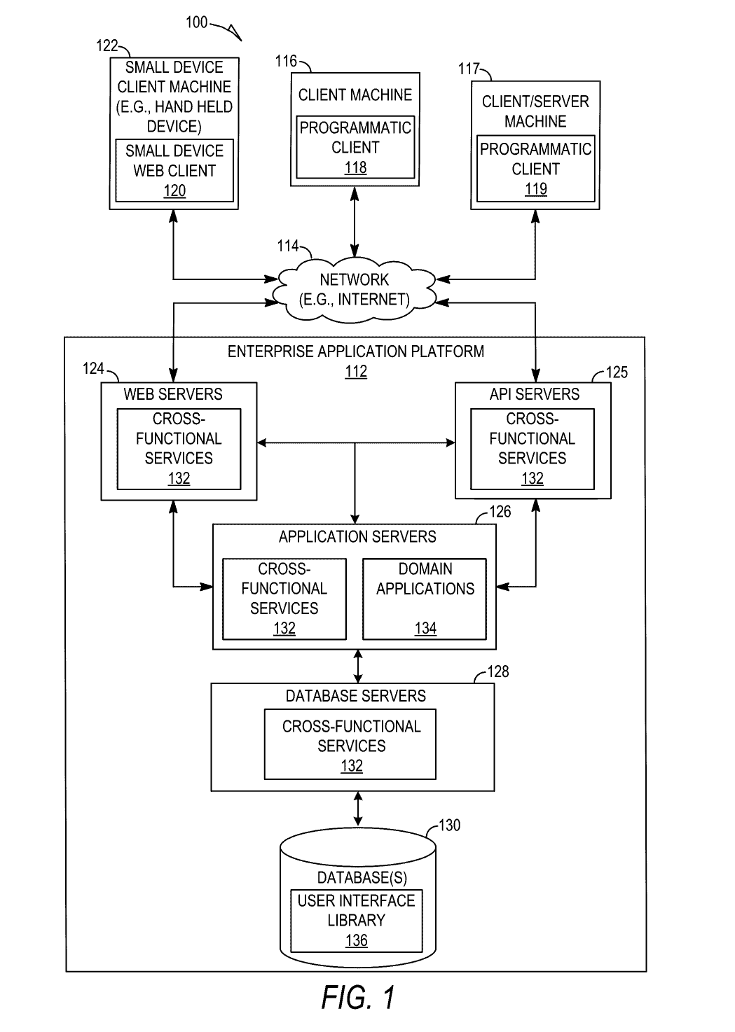

FIG. 1 is a network diagram illustrating a client-server system 100, in accordance with some example embodiments. A platform (e.g., machines and software), in the example form of an enterprise application platform 112, provides server-side functionality, via a network 114 (e.g., the Internet) to one or more clients. FIG. 1 illustrates, for example, a client machine 116 with programmatic client 118 (e.g., a browser), a small device client machine 122 with a small device web client 120 (e.g., a browser without a script engine), and a client/server machine 117 with a programmatic client 119.

Turning specifically to the example enterprise application platform 112, web servers 124 and Application Program Interface (API) servers 125 can be coupled to, and provide web and programmatic interfaces to, application servers 126. The application servers 126 can be, in turn, coupled to one or more database servers 128 that facilitate access to one or more databases 130. The cross-functional services 132 can include relational database modules to provide support services for access to the database(s) 130, which includes a user interface library 136. The web servers 124, API servers 125, application servers 126, and database servers 128 can host cross-functional services 132. The application servers 126 can further host domain applications 134.

The cross-functional services 132 provide services to users and processes that utilize the enterprise application platform 112. For instance, the cross-functional services 132 can provide portal services (e.g., web services), database services and connectivity to the domain applications 134 for users that operate the client machine 116, the client/server machine 117 and the small device client machine 122. In addition, the cross-functional services 132 can provide an environment for delivering enhancements to existing applications and for integrating third-party and legacy applications with existing cross-functional services 132 and domain applications 134. Further, while the system 100 shown in FIG. 1 employs a client-server architecture, the embodiments of the present disclosure are of course not limited to such an architecture, and could equally well find application in a distributed, or peer-to-peer, architecture system.

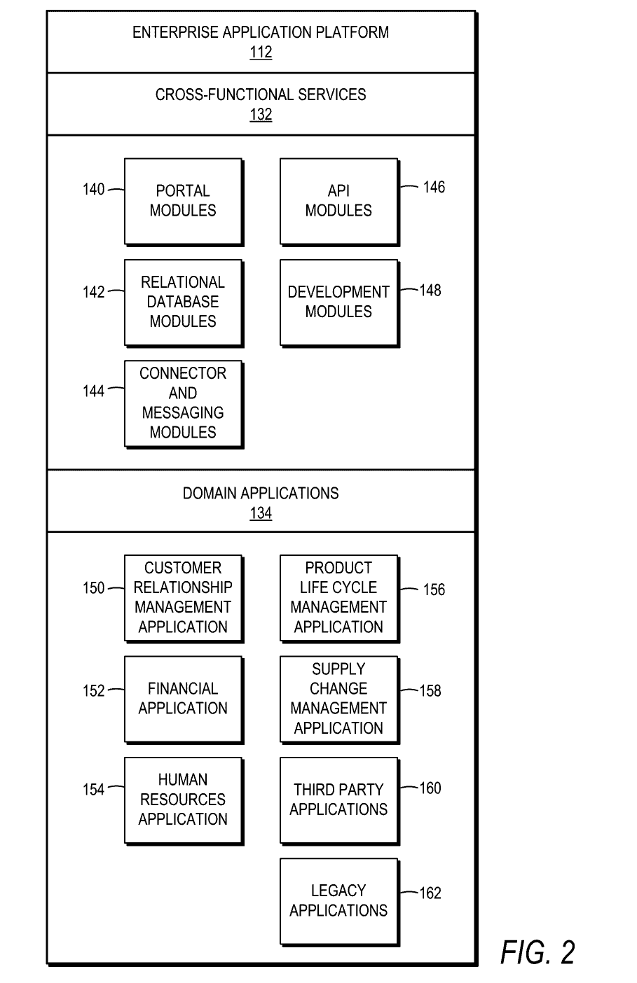

The enterprise application platform 112 can implement partition level operation with concurrent activities. For example, the enterprise application platform 112 can implement a partition level lock, a schema lock mechanism, manage activity logs for concurrent activity, generate and maintain statistics at the partition level, and efficiently build global indexes. The enterprise application platform 112 is described in greater detail below in conjunction with FIG. 2.

FIG. 2 is a block diagram illustrating enterprise applications and services in an enterprise application platform 112, in accordance with an example embodiment. The enterprise application platform 112 can include cross-functional services 132 and domain applications 134. The cross-functional services 132 can include portal modules 140, relational database modules 142, connector and messaging modules 144, API modules 146, and development modules 148.

The portal modules 140 can enable a single point of access to other cross-functional services 132 and domain applications 134 for the client machine 116, the small device client machine 122, and the client/server machine 117. The portal modules 140 can be utilized to process, author and maintain web pages that present content (e.g., user interface elements and navigational controls) to the user. In addition, the portal modules 140 can enable user roles, a construct that associates a role with a specialized environment that is utilized by a user to execute tasks, utilize services and exchange information with other users and within a defined scope. For example, the role can determine the content that is available to the user and the activities that the user can perform. The portal modules 140 include a generation module, a communication module, a receiving module and a regenerating module. In addition the portal modules 140 can comply with web services standards and/or utilize a variety of Internet technologies including Java, J2EE, SAP's Advanced Business Application Programming Language (ABAP) and Web Dynpro, XML, JCA, JAAS, X.509, LDAP, WSDL, WSRR, SOAP, UDDI and Microsoft .NET.

The relational database modules 142 can provide support services for access to the database(s) 130, which includes a user interface library 136. The relational database modules 142 can provide support for object relational mapping, database independence and distributed computing. The relational database modules 142 can be utilized to add, delete, update and manage database elements. In addition, the relational database modules 142 can comply with database standards and/or utilize a variety of database technologies including SQL, SQLDBC, Oracle, MySQL, Unicode, JDBC, or the like.

The connector and messaging modules 144 can enable communication across different types of messaging systems that are utilized by the cross-functional services 132 and the domain applications 134 by providing a common messaging application processing interface. The connector and messaging modules 144 can enable asynchronous communication on the enterprise application platform 112.

The API modules 146 can enable the development of service-based applications by exposing an interface to existing and new applications as services. Repositories can be included in the platform as a central place to find available services when building applications.

The development modules 148 can provide a development environment for the addition, integration, updating and extension of software components on the enterprise application platform 112 without impacting existing cross-functional services 132 and domain applications 134.

Turning to the domain applications 134, the customer relationship management application 150 can enable access to and can facilitate collecting and storing of relevant personalized information from multiple data sources and business processes. Enterprise personnel that are tasked with developing a buyer into a long-term customer can utilize the customer relationship management applications 150 to provide assistance to the buyer throughout a customer engagement cycle.

Enterprise personnel can utilize the financial applications 152 and business processes to track and control financial transactions within the enterprise application platform 112. The financial applications 152 can facilitate the execution of operational, analytical and collaborative tasks that are associated with financial management. Specifically, the financial applications 152 can enable the performance of tasks related to financial accountability, planning, forecasting, and managing the cost of finance.

The human resource applications 154 can be utilized by enterprise personnel and business processes to manage, deploy, and track enterprise personnel. Specifically, the human resource applications 154 can enable the analysis of human resource issues and facilitate human resource decisions based on real time information.

The product life cycle management applications 156 can enable the management of a product throughout the life cycle of the product. For example, the product life cycle management applications 156 can enable collaborative engineering, custom product development, project management, asset management and quality management among business partners.

The supply chain management applications 158 can enable monitoring of performances that are observed in supply chains. The supply chain management applications 158 can facilitate adherence to production plans and on-time delivery of products and services.

The third-party applications 160, as well as legacy applications 162, can be integrated with domain applications 134 and utilize cross-functional services 132 on the enterprise application platform 112.

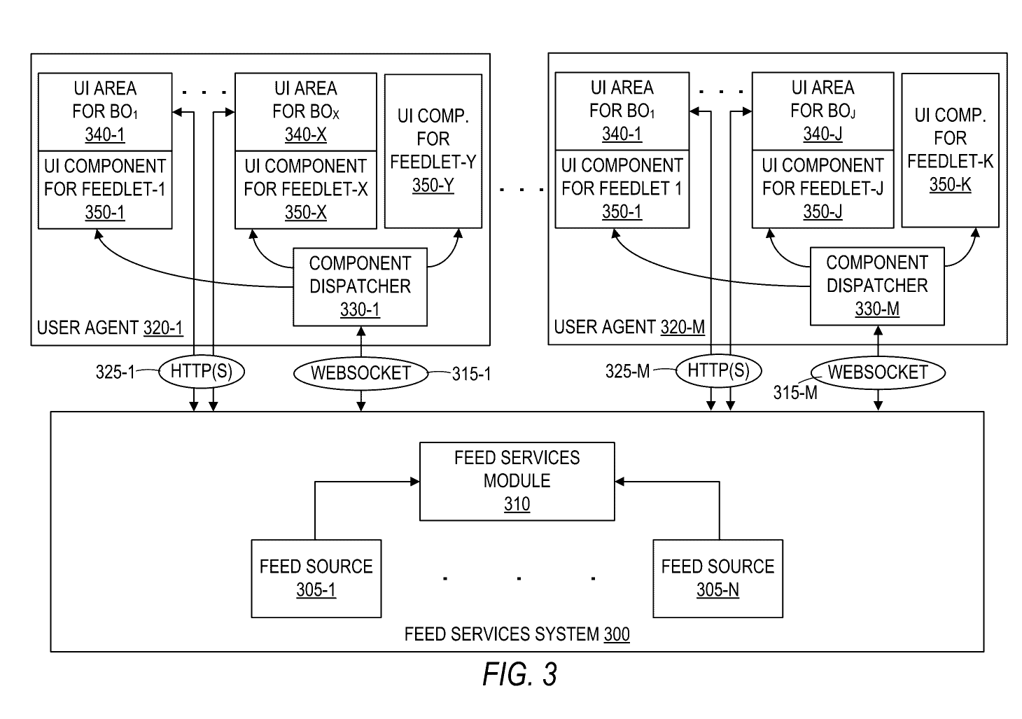

FIG. 3 is a block diagram illustrating a feed services system 300, in accordance with some example embodiments. The feed services system 300 provides a coherent infrastructure across multiple software applications, such as business applications. In some example embodiments, the feed services system 300 provides the availability of a common feed (e.g., push events and messages), and definition and directory service in business systems across different software layers for usability and end user experience consistency for all business applications (e.g., to enable a common look and feel of the feeds in the established UIs), including in the case of composite applications consisting of different applications, such as Enterprise Resource Planning (ERP), Customer Relationship Management (CRM), and Storage Resource Management (SRM). In some example embodiments, the feed services system 300 provides a common infrastructure for definition, implementation, registrations, and discovery of feeds across any number of software applications.

In some example embodiments, the feed services system 300 provides a feedlet definition service, which includes the implementation of common interfaces by the feedlet provider and comprises the following information: (1) feedlet ID and its documentation; (2) recommended UI component; (3) subscription/un-subscription of the feedlets for consumers; and (4) publication of information to all subscribers (e.g., based on publish-subscribe or point-to-point communication pattern). The term “feedlet” is used herein to refer to one of a plurality of feeds.

In some example embodiments, the feed services system 300 provides a feedlet security service that defines the access right of a feedlet (e.g., public, domain-specific, role-based). The feedlet service provider provides this information during the implementation phase. Additionally, this information is used in the discovery service and in the activation phase of a feedlet to check the access rights.

In some example embodiments, the feed services system 300 provides a feedlet directory service in the form of a registration API for the public, domain-specific or role-based feedlets. The feed services system 300 can also provide a discovery service in the form of an access API for the registered public, domain-specific or role-based feedlets.

In some example embodiments, the feed services system 300 provides a feedlet supportability service comprising logging, tracing, and debugging capabilities during the whole lifecycle of feedlets (e.g., implementation, test, and productive usage phase).

For the implementation of feedlet services, performance and resource consumption are a major concern when dealing with large number of users and feeds. Thus, the present disclosure contemplated the usage of an effective server/backend push service (e.g., WebSocket). In some example embodiments, ABAP channels (e.g., ABAP push and messaging channels) provide the push technology employed for the feed services disclosed herein. In addition to a technical push infrastructure, the present disclosure also provides a common message structure containing the metadata information for the consumption of established feeds. In some example embodiments, this common message structure is achieved by extending a push channel protocol (PCP) in that way to contain the required metadata information for the feedlet services.

In some example embodiments all subscribed feedlets per client (e.g., per user-agent) share a single WebSocket connection (e.g., ABAP push channel) for consumption of different types of associating push messages (e.g., feedlets) for changes applied to different business objects, or notification regarding incoming external information (e.g., news, weather, sport, chat, activation/deactivation of logs, traces, debugging, etc.). This use of a single common WebSocket connection will avoid the unnecessary creation of parallel WebSocket connections for each feedlet, which is a limited resource at the both communication sides (e.g., at the client and at the server). Any additional WebSocket connection leads to performance degradation due to WebSocket protocol specific network traffic (e.g., due to keeping alive ping-pongs packages). Furthermore, the lifecycle handling of the WebSockets leads to additional complexity at both communication sides. Moreover, the situation will worsen when UI dependencies between different feedlets exist (e.g., because a UI area contains an aggregation of information provided by different feedlet providers).

Most of the UI frameworks (e.g., Web Dynpro, WebGUI, Business Server Pages, etc.) and also business applications that handle collaboration scenarios are usually interested in a number of feeds. A “feed” is used herein as a synonym for push services (e.g., push services based on ABAP channels) which publish information to a dedicated domain/subject, such as changes applied to a business object, or notification regarding incoming of various external news (e.g., weather, sport, chat). In some example embodiments, in order to establish a service-oriented infrastructure for the ABAP push services, the availability of a common messaging protocol is employed. The use of a common messaging protocol can also be employed for most service-oriented infrastructure (e.g., SOA, REST, or OData based services), thus enabling the application developer to consume the services in the same way.

In some example embodiments, the WebGUI framework takes use of a single WebSocket connection to consume one or more of the following events/feeds: (1) pushing system messages, which are maintained in the transaction SM02, in real-time to the UI session without any interaction on the UI screen; (2) pushing SAPGUI progress indicator information (e.g., either by processing the function module SAPGUI_PROGRESS_INDICATOR or generation of ABAP load in kernel, which was reserved for native SAPGUI connections, to the UI); (3) pushing the HTTP session timeout event to the UI (the session timeout occurs due to inactivity timeout for HTTP stateful sessions); and (4) push notification replacing polling technology used to detect the end of the transformation of UI elements (e.g., dynpros, list or ALV, to a PDF document).

In some example embodiments, the feed services system 300 provides a single WebSocket connection per client (e.g., browser tab/UI application) for the consumption of different feeds. The use of this single shared WebSocket connection will avoid the unnecessary creation of parallel WebSocket connections per feed, which is a limited resource at both sides of the communication end point (e.g., at the client and at the server). Any additional WebSocket connection leads to performance degradation due to WebSocket protocol specific network traffic (e.g., due to keeping alive ping-pongs packages). Furthermore the lifecycle handling of the WebSockets will lead to additional complexity at both sides of the communication.

Referring back to FIG. 3, the feed services system 300 comprises a feed services module 310. In some example embodiments, the feed services module 300 resides on a machine having a memory and at least one processor (e.g., application server(s) 126 or database server(s) 128 in FIG. 1).

In some example embodiments, the feed services module 310 is configured to receive feed data from a plurality of different feed sources 305 (e.g., feed source 305-1, . . . , feed source 305-N). The feed data can be any data of a data feed (e.g., updated data). In some example embodiments, the feed sources 305 are incorporated into the database(s) 130 in FIG. 1. However, it is contemplated that other configurations of the feed sources 305 are also within the scope of the present disclosure.

In some example embodiments, in response to or otherwise based on receiving the feed data, the feed services module 310 is configured to generate a message based on the feed data and a messaging protocol. The message can comprise the feed data and context information. In some example embodiments, the context information is generated according to the messaging protocol and indicates an application on a computing device. The computing device can comprise a user agent, such as user agent 320 in FIG. 3. A plurality of user agents 320 (e.g., user agent 320-1, . . . , user agent 320-M) can be spread amongst a plurality of computing devices (e.g., one user agent 320 for each computing device), or a plurality of user agents 320 can reside on the same computing device.

In some example embodiments, the application indicated in the message comprises a business application. Each user agent 320 can correspond to a separate instance of the same business application or can correspond to a different business application altogether. In some example embodiments, each application can comprise one or more business objects (BOs), which can be updated based on the feed data. Accordingly, each application can comprise a corresponding user interface area 340 for each of its business objects (e.g., UI areas 340-1 for BO₁, . . . , UI area 340-X for BO_{X} in user agent 320-1, and UI areas 340-1 for BO₁, . . . , UI area 340-J for BO_{J} in user agent 320-M).

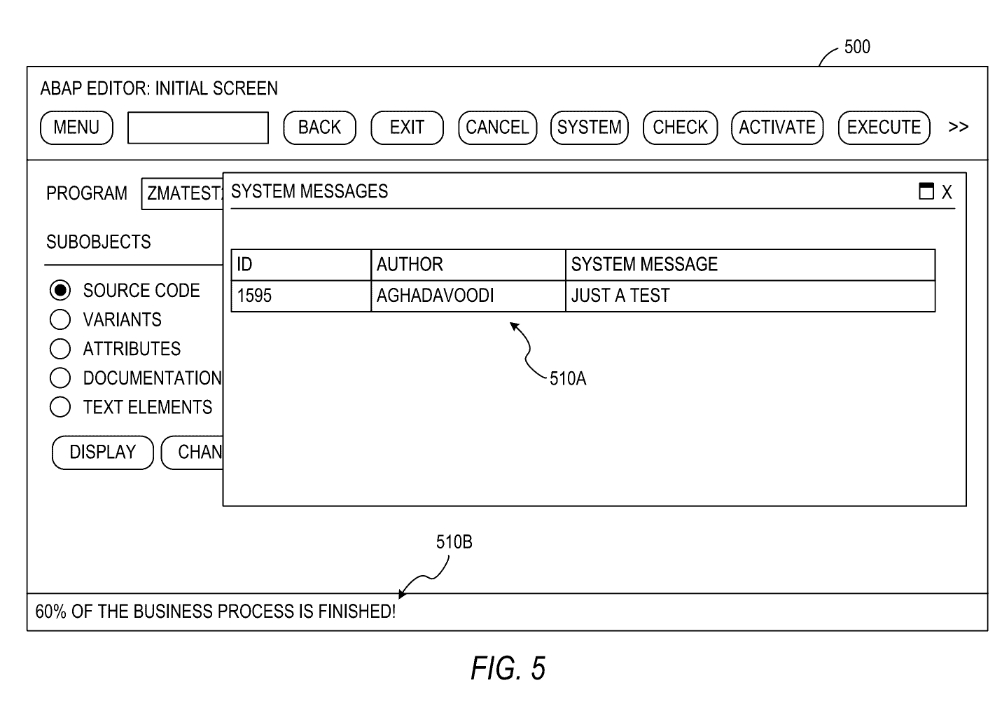

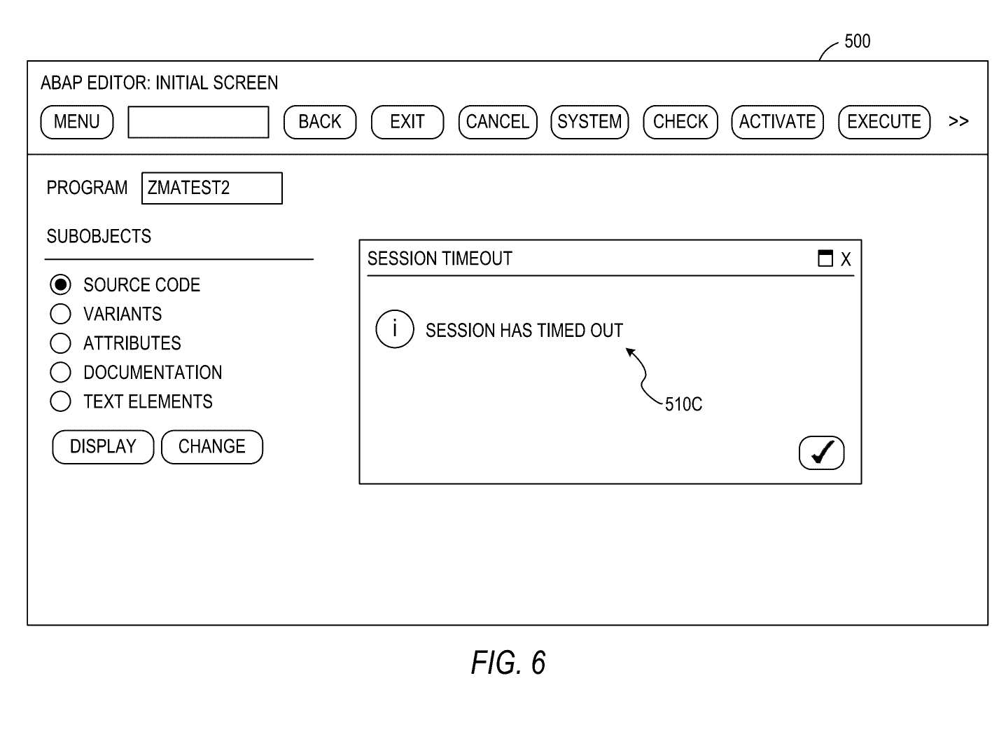

FIG. 5 illustrates a graphical user interface 500 displaying a visualization of feed data being used by a business application, in accordance with some example embodiments. In the example in FIG. 5, feed data 510A comprises a system message that has been received, including a corresponding message ID (e.g., “1595”), a corresponding message author (e.g., “Aghadavoodi”), and the content of the message (e.g., “Just a test”), and feed data 510B comprises an indication of the status of a business process (e.g., “60% of the business process is finished!”). FIG. 6 illustrates the graphical user interface 500 displaying another visualization of feed data being used by the business application, in accordance with some example embodiments. In the example in FIG. 6, feed data 510C comprises an indication that the session has timed out. The feed data 510A-510C can each have a corresponding user interface area 340 and business object of the business application.

Referring back to FIG. 3, the application can request a feedlet for a specific UI area 340 for a specific business object. The application can submit a request for this feedlet to the feed services module 310 via a corresponding HTTP(S) connection 325 (e.g., HTTP(S) connection 325-1 for the application on user agent 320-1, . . . , HTTP(S) connection 325-M for the application on user agent 320-M).

In some example embodiments, the feed services module 310 can establish a single WebSocket connection 315 for multiple feedlets of feed data from multiple feed sources 305 (e.g., feed source 305-1, . . . , feed source 305-N). In this respect, the feed services system 300 can provide a single commonly shared WebSocket connection for multiple feedlets. In some example embodiments, each user agent 320 can have a single corresponding WebSocket connection 315 for providing feed data from multiple different feed sources 305 to one or more applications on the user agent 320.

As previously discussed, in some example embodiments, in response to or otherwise based on receiving the feed data, the feed services module 310 is configured to generate a message based on the feed data and a messaging protocol. The message can comprise the feed data and context information. In some example embodiments, the context information is generated according to the messaging protocol and indicates an application on a computing device. In some example embodiments, the feed services module 310 is configured to transmit the generated message to a corresponding component dispatcher 330 on the computing device (e.g., component dispatcher 330-1 on user agent 320-1, . . . , component dispatcher 330-M on user agent 320-M) via a corresponding WebSocket connection 315. In some example embodiments, the component dispatcher 330 is configured to transmit the feed data to the corresponding application based on the context information of the generated message.

Messages corresponding to different feed sources 305 are generated based on the same single messaging protocol. In some example embodiments, in order to enable consumption of different feeds by a single WebSocket connection, a common higher protocol and message type is employed on top of WebSocket for those feeds which are pushed from the feed services system 300. In the WebSocket message handling (e.g., event loop) at the UI client side (e.g., at the corresponding component dispatcher 330), this common higher protocol provides a unique and reliable way to find out to which feed the arrived message belongs, in order to process it appropriately and to update the correct UI area 340.

The messaging protocol of the present disclosure provides a message envelop similar to an HTTP message format. This messaging protocol is referred to herein as a push channel protocol (PCP). In some example embodiments, the PCP extends the message to contain context information and metadata, such as the content type (XML, JSON, binary) or custom information.

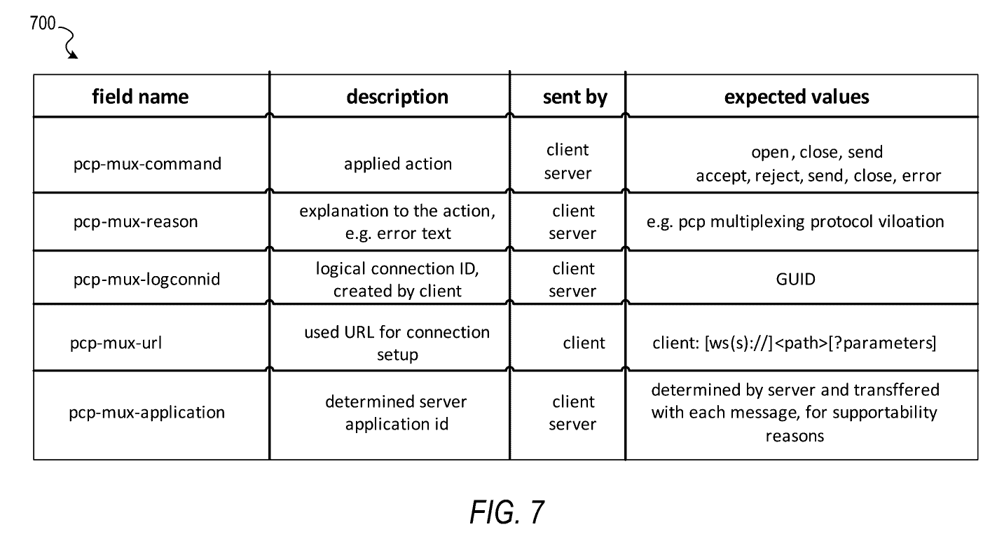

FIG. 7 is a table 700 of messaging protocol fields that can be used for the messaging protocol of the present disclosure, in accordance with some example embodiments. In some example embodiments, the messages generated, transmitted, and received by the feed services module 310 comprise one or more of these messaging protocol fields, which include a command field (e.g., pcp-mux-command) for describing the applied action, a reason field (e.g., pcp-mux-reason) for describing an explanation to the action, a logical connection ID field (e.g., pcp-mux-logconnid) for identifying the logical connection ID being used, a uniform resource locator (URL) field (e.g., pcp-mux-url) for identifying the URL used for the connection setup, and an application field (e.g., pcp-mux-application) for identifying the appropriate application (e.g., the application to which the feed data is to be transmitted).

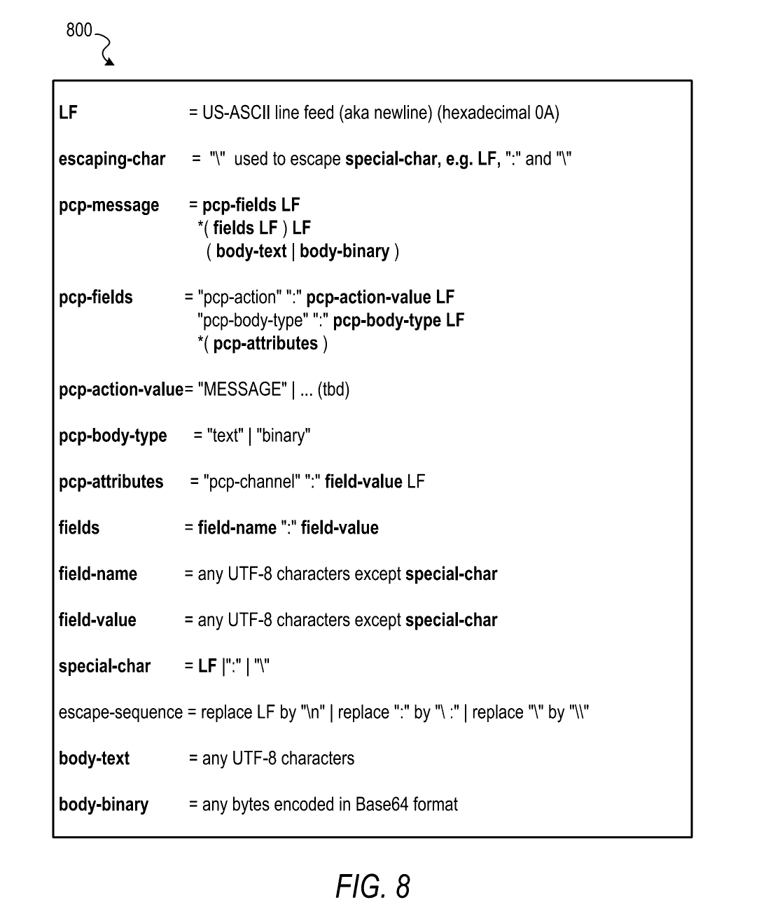

A PCP message can be more formally described using the Backus-Naur Form (BNF) grammar used in HTTP/1.1. FIG. 8 is a description of a message of the messaging protocol using the BNF grammar, in accordance with some example embodiments. In some example embodiments, the PCP is a message-based protocol that can be used in the context of ABAP Channels (e.g., ABAP messaging and ABAP Push Channels), as well as in other contexts. The message structure can absent the start-line (request-line, response-line) entry of an HTTP message. In some example embodiments, the PCP messages consist of header fields and a plain body which are separated by line feeds (LF). A field entry contains a <name> and <value> pairs separated by “:” character, i.e. <name>:<value>. The names and values can be in UTF-8 characters and can be case-sensitive. In some example embodiments, the names and value do not contain the special characters LF (\n in hexadecimal OA). Each field entry, i.e. <name>-<value>, can be terminated by LF. The last field entry can be completed with double LF, i.e. LFLF, independently of the existence of a body. In case of availability of a body, this content can be appended after the double LFs. In some example embodiments, the body contains only UTF8 characters, and the body in binary is encoded in Base64 format.

With the increased number of WebSocket applications and push services consumed in a business application, the present disclosure provides a WebSocket multiplexing to reduce not only the number of concurrent WebSockets in an HTML5 browser's client plus the associating sockets on the application server. The multiplexing leads also to reduced complexity regarding the lifecycle of connections per client and also composite applications consuming several push/WebSocket services. In some example embodiments, the feed services system 300 uses a PCP message to tunnel the WebSocket connections on a single technical WebSocket connection. In some example embodiments, the feed services system 300 employs the existing standard W3C WebSocket API kept as it is and adds a PCP multiplexing library.

Referring back to FIG. 3, in some example embodiments, the component dispatcher 330 is configured to receive the messages (e.g., PCP messages) from the feed services module 310, parse the messages for the corresponding context information, determine the corresponding application for the based on the corresponding context information, and then transmit the corresponding feed data of the corresponding message to the corresponding application on the user agent 320. In some example embodiments, the component dispatcher transmits the feed data to a corresponding UI component 350 for the corresponding feedlet of the corresponding feed data (e.g., UI component 350-1 for feedlet-1, . . . , UI component 350-X for feedlet-X). The UI component 350 can then use the corresponding feed data to update the corresponding UI area 340, such as by updating the corresponding business object. In some example embodiments, a UI component, such as UI component 350-Y or UI component 350-K in FIG. 3, does not have a corresponding UI area for a corresponding business object, but is still provided with feed data from a corresponding feedlet (e.g., feedlet-Y or feedlet-K) for some other use in the corresponding application.

In some example embodiments, the feed services module 310 and the component dispatcher 330 are configured to act as multiplexers. For example, the feed services module 310 can receive different feed data from a plurality of different feed sources 305, generate corresponding messages based on the received feed data, and then transmit the generated messages to a single component dispatcher 330 over a single WebSocket 315. The generated message can be sent as a batch or based on a queueing system. Additionally, the component dispatcher 330 can receive the multiple messages corresponding to different feed sources 305 and transmit the corresponding feed data of the messages to the corresponding ones of a plurality of applications and/or UI components 350 of the applications.

In some example embodiments, the feed services module 310 is configured to use the PCP in generating a message comprising feed data regardless of whether or not the feed services module 310 is performing any multiplexing features. For example, in some example embodiments, the feed services module 310 is configured to receive feed data from a feed source 305, to generate a message based on the feed data and the PCP, with the generated message comprising the feed data and context information indicating an application on a computing device (or a UI area or a business object or some other intended target for the feed data), and to transmit the generated message to the computing device, which can be configured to transmit the feed data to an application on the computing device based on the context information.

In some example embodiments, the feed services module 310 is configured to enable a user to create a feedlet or implement a feedlet in the feed services system 300. For example, the user can register a feed source 305 with the feed services module 310, such as by using a user interface provided by the feed services module 310. During the registration of the feed source 305, the user can provide information identifying the feed source 305 and/or its location via the user interface.

In some example embodiments, the feed services module 310 is configured to determine the appropriate target to which to direct the feed data from the newly registered feed source 305, such as the appropriate user agent(s) 320, application(s), business object(s), or UI area(s) 340. This determination can be based on an explicit identification by the user registering the feed source 305. In some example embodiments, the feed services module is configured to determine one or more categories (e.g., news, social network profile data, stock prices, etc.) of the newly registered feed source 305. This determination can be based on any combination of one or more of the identification of the feed source 305, an explicit identification of a category of the newly registered feed source 305 by the user via the user interface of the feed services module 310, and an analysis of the feed data provided by the newly registered feed source 305. In some example embodiments, the feed service module 310 is configured to use this category determination to determine one or more targets to which to direct the feed data from the newly registered feed source 305, such as by comparing the category determination with corresponding category information of potential targets (e.g., metadata indicating a category of an application), and determining a potential target to be a target of the newly registered feed source 305 based on this comparison indicating a sufficient level of relevancy (e.g., exceeding a minimum threshold level of relevancy) between the feed source 305 and the potential target.

In some example embodiments, the feed services module 310 is configured to automatically subscribe the determined target(s) to the newly registered feed source 305 in response to the determination of the target(s) discussed above. In some example embodiments, the feed services module 310 is configured to transmit a notification to the user agent(s) 320 corresponding to the determined target(s) of the newly registered feed source 305, with the notification being configured to enable an authorized user of the user agent(s) 320 to explicitly authorize subscription to the newly registered feed source 305, such as by sending a confirmation reply to the feed service module 310. The feed services module 310 can then subscribe that target to the newly registered feed source 305 based on this explicit authorization.

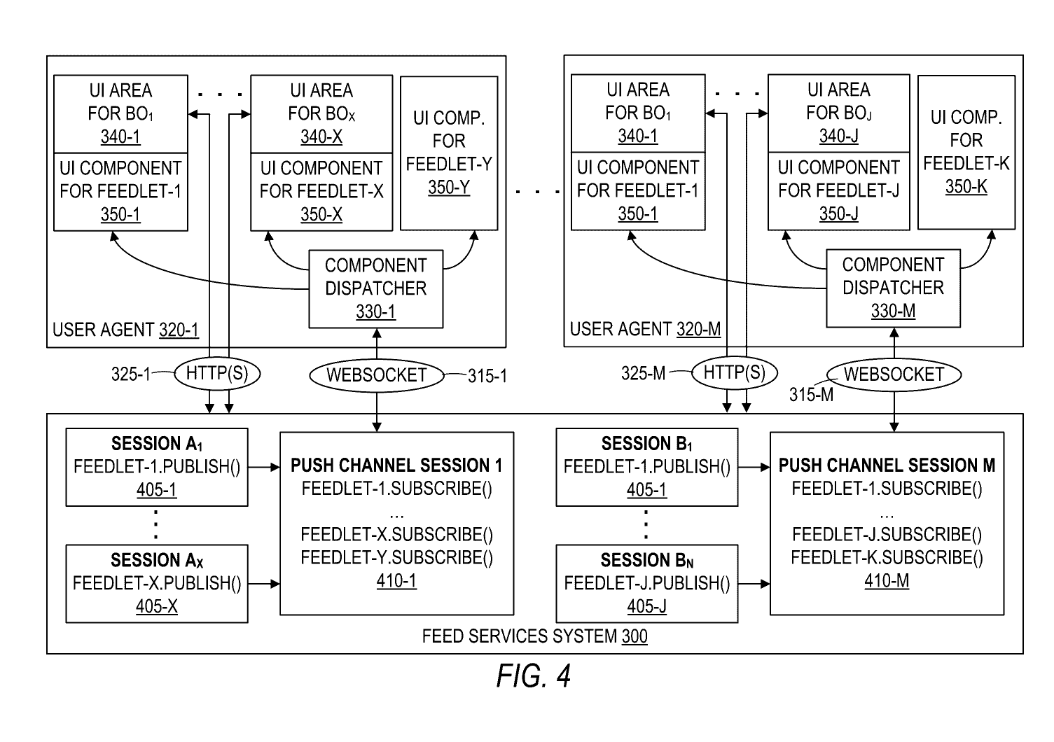

FIG. 4 is a block diagram illustrating communication sessions of the feed services system 300, in accordance with some example embodiments. In the example embodiment of FIG. 4, subscribed feedlets in push channel sessions (push channel sessions 1 . . . M) and in their associating UI applications (user agents 1 . . . M) are used to receive and process messages from various sessions (session A₁ . . . B_{N}). Those messages are received and processed in the UI applications by the component dispatcher 330, which dispatches the arrived message (e.g., from feedlet-1) to the feedlet assigned UI component (e.g., UI component for feedlet-1).

In FIG. 4, a corresponding push channel session 410 is implemented for each corresponding user agent 320 (e.g., push channel session 1 410-1 for user agent 320-1, . . . , push channel session M 410-M for user agent 320-M). Each push channel session 410 receives feed data from corresponding feedlet sessions 405 (e.g., session A₁ for feedlet-1, . . . , session A_{X} for feedlet-X, and session B1 for feedlet-1, . . . , session B_{N} for feedlet-J).

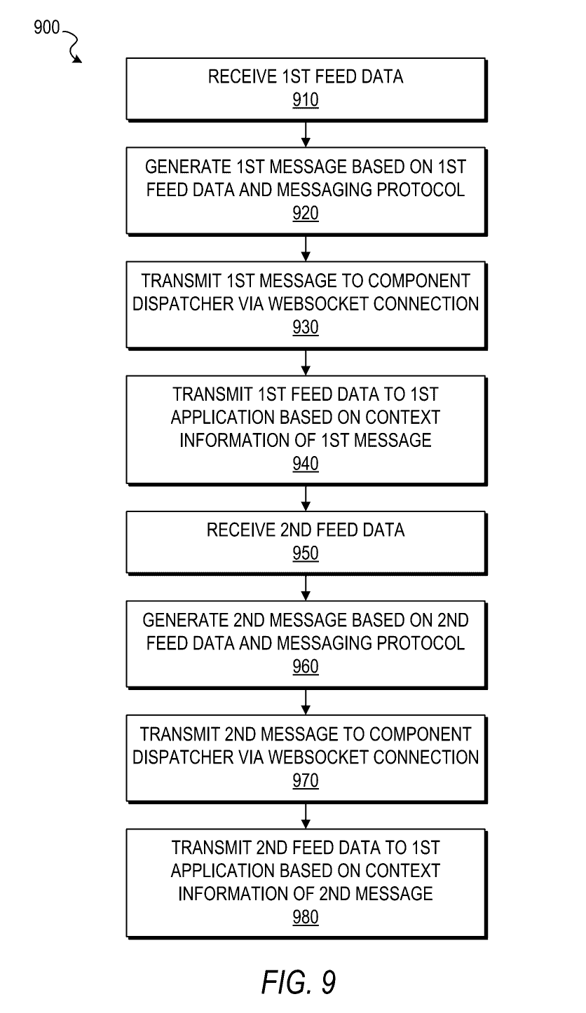

FIG. 9 is a flowchart illustrating a method 900 of providing feed services, in accordance with some example embodiments. Method 900 can be performed by processing logic that can comprise hardware (e.g., circuitry, dedicated logic, programmable logic, microcode, etc.), software (e.g., instructions run on a processing device), or a combination thereof. In one example embodiment, the operations of method 900 are performed by either the feed services system 300 or the user agent 320 of FIG. 3, or any combination of one or more of their components or modules, as described above.

At operation 910, first feed data is received by a feed services module from a first feed source. At operation 920, a first message is generated by the feed services module based on the first feed data and a messaging protocol. The first message comprises the first feed data and first context information. The first context information is generated according to the messaging protocol and indicates a first application on a first computing device. At operation 930, the first message is transmitted by the feed services module to a first component dispatcher on the first computing device via a first WebSocket connection. The first component dispatcher is configured to transmit the first feed data to the first application based on the first context information. At operation 940, the first component dispatcher transmits the first feed data to the first application based on the context information of the first message. At operation 950, second feed data is received by the feed services module from a second feed source different from the first feed source. At operation 960, a second message is generated by the feed services module based on the second feed data and the messaging protocol. The second message comprises the second feed data and second context information. The second context information is generated according to the messaging protocol and indicates the first application on the first computing device. At operation 970, the second message is transmitted by the feed services module to the first component dispatcher via the first WebSocket connection. The first component dispatcher is configured to transmit the second feed data to the first application based on the second context information. At operation 980, the first component dispatcher transmits the second feed data to the first application based on the context information of the second message.

It is contemplated that any of the other features described within the present disclosure can be incorporated into method 900.

In some example embodiments, the first context information indicates a first user interface area of the first application corresponding to a first business object, with the first feed data being used to update the first user interface area of the first application, and the second context information indicates a second user interface area of the first application corresponding to a second business object, with the second feed data being used to update the second user interface area of the first application.

In some example embodiments, the first message and the second message are each absent a HTTP start-line. In some example embodiments, the Web Socket connection comprises an ABAP push channel connection.

In some example embodiments, the method 900 further comprises generating a third message based on the first feed data and the messaging protocol, with the third message comprising the first feed data and third context information, and the third context information being generated according to the messaging protocol and indicating a second application on a second computing device, and then transmitting the third message to a second component dispatcher on the second computing device via a second Web Socket connection, with the second component dispatcher being configured to transmit the first feed data of the third message to the second application on the second computing device based on the third context information.

In some example embodiments, the method 900 further comprises generating a fourth message based on the first feed data and the messaging protocol, with the fourth message comprising the first feed data and fourth context information, and the fourth context information being generated according to the messaging protocol and indicating a third application on the first computing device, and then transmitting the fourth message to the first component dispatcher on the first computing device via the first WebSocket connection, with the first component dispatcher being configured to transmit the first feed data of the fourth message to the third application on the first computing device based on the fourth context information.

In some example embodiments, the method 900 further comprises receiving third feed data from the first feed source, generating a fifth message based on the third feed data and the messaging protocol, with the fifth message comprising the third feed data and fifth context information, and the fifth context information being generated according to the messaging protocol and indicating the first application on the first computing device, and then transmitting the fifth message to the first component dispatcher on the first computing device via the first WebSocket connection, with the first component dispatcher being configured to transmit the third feed data of the fifth message to the first application on the first computing device based on the fifth context information.

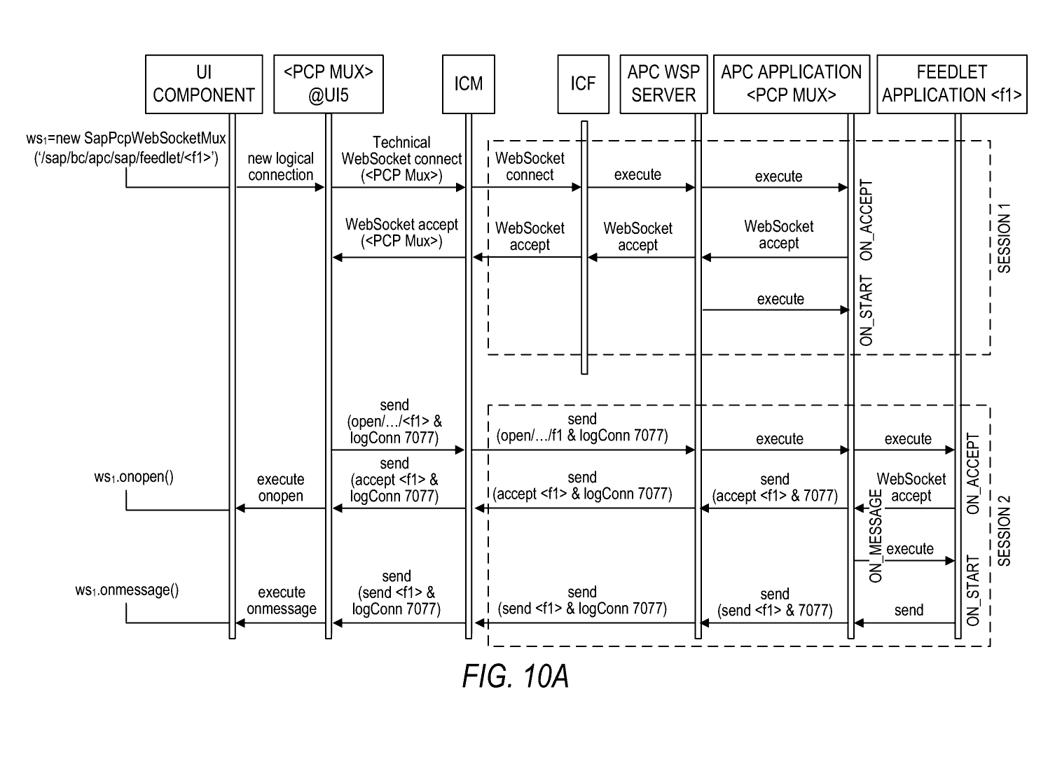

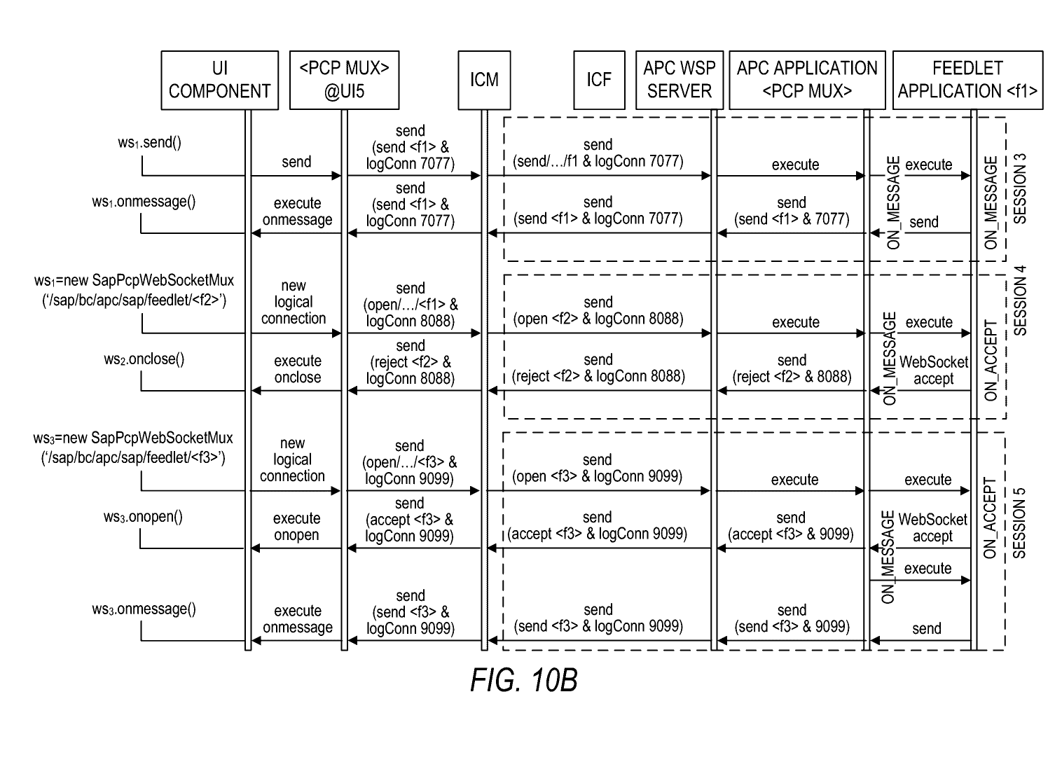

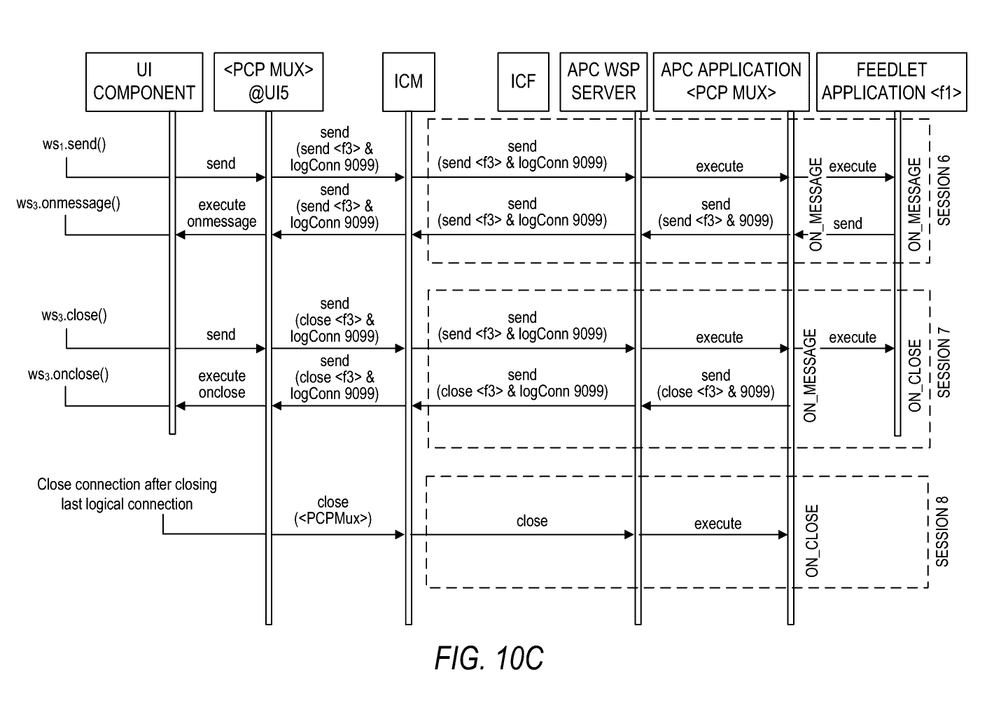

FIGS. 10A-10C illustrate a WebSocket multiplexing interaction model using the messaging protocol, in accordance with some example embodiments. In some example embodiments, a SapPcpWebSocketMux library comprises a JavaScript application, such as a UI component, able to create a logical WebSocket connection. The library can be responsible for the tunneling of the logical connections on a technical WebSocket connection using the PCP of the present disclosure. The technical connection can be initiated (e.g., using lazy initialization) with the initial instantiation of the library (new SapPcpWebSocketMux( . . . )). A dedicated backend APC application (e.g., <PCP MUX>) can be provided for the establishment of the technical WebSocket connection.

FIG. 10A shows a first session, SESSION 1, in which a technical WebSocket connection is established between a user agent 320 and the feed services system 300. In some example embodiments, the UI component and a component dispatcher (<PCP MUX>@UI5) reside on the user agent 320, while an internet communication manager (ICM), an internet communication framework (ICF), a push channel server (APC WSP SERVER), and an APC application (<PCP MUX>, e.g., feed services module 310) reside on the feed services system 300. In FIGS. 10A-10C, over the course of multiple sessions, SESSIONS 2-8, a single WebSocket is used to attempt to provide feed data of different feedlets, feedlets <f1>, <f2>, and <f3>, to the corresponding UI component through the component dispatcher (<PCP MUX>@UI5).

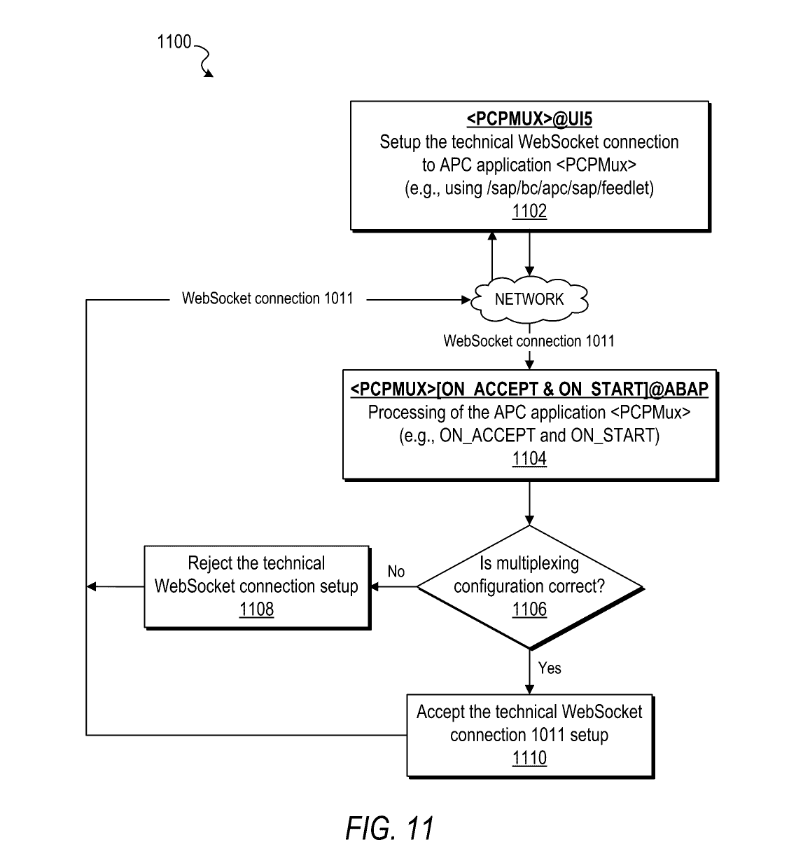

FIG. 11 illustrates a process flow 1100 for a technical WebSocket connection setup, in accordance with some example embodiments. Although specific steps, components, identifiers, and values are provided with respect to the operations of FIG. 11, it is contemplated that modifications to these details are also within the scope of the present disclosure.

At operation 1102, the <PCP MUX>@UI5 (e.g., a component dispatcher 330) performs a setup of the technical WebSocket connection to APC application <PCP Mux>, such as by using the path “/sap/bc/apc/sap/feedlet.” At operation 1104, the <PCP MUX>@ABAP (e.g., the feed services module 310) performs processing of the APC application <PCP MUX>. At operation 1106, it is determined whether or not the multiplexing configuration is correct. If it is determined that the multiplexing configuration is not correct, then the technical WebSocket connection setup is rejected at operation 1108. If it is determined that the multiplexing configuration is correct, then the technical WebSocket connection 1011 setup is accepted at operation 1110.

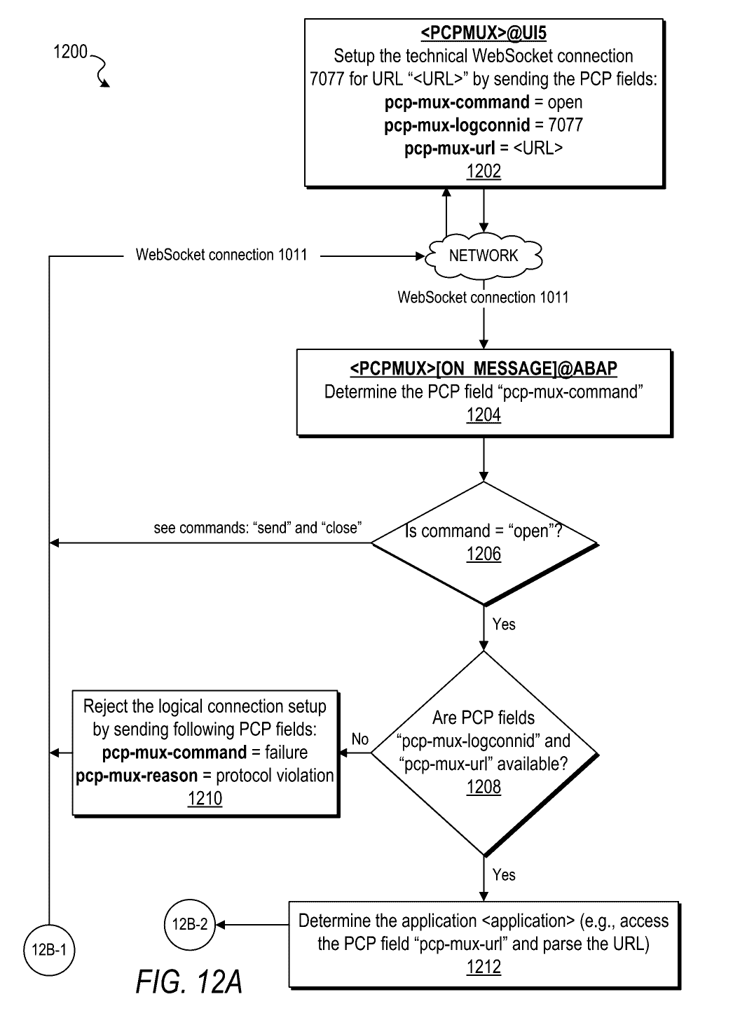

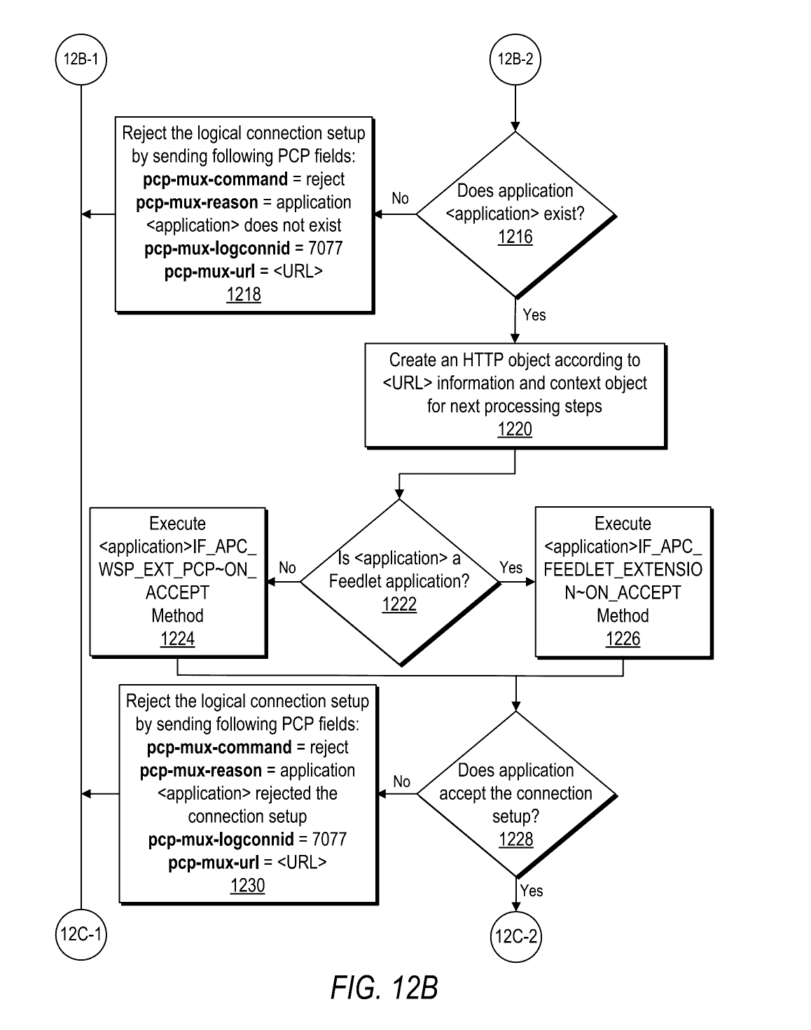

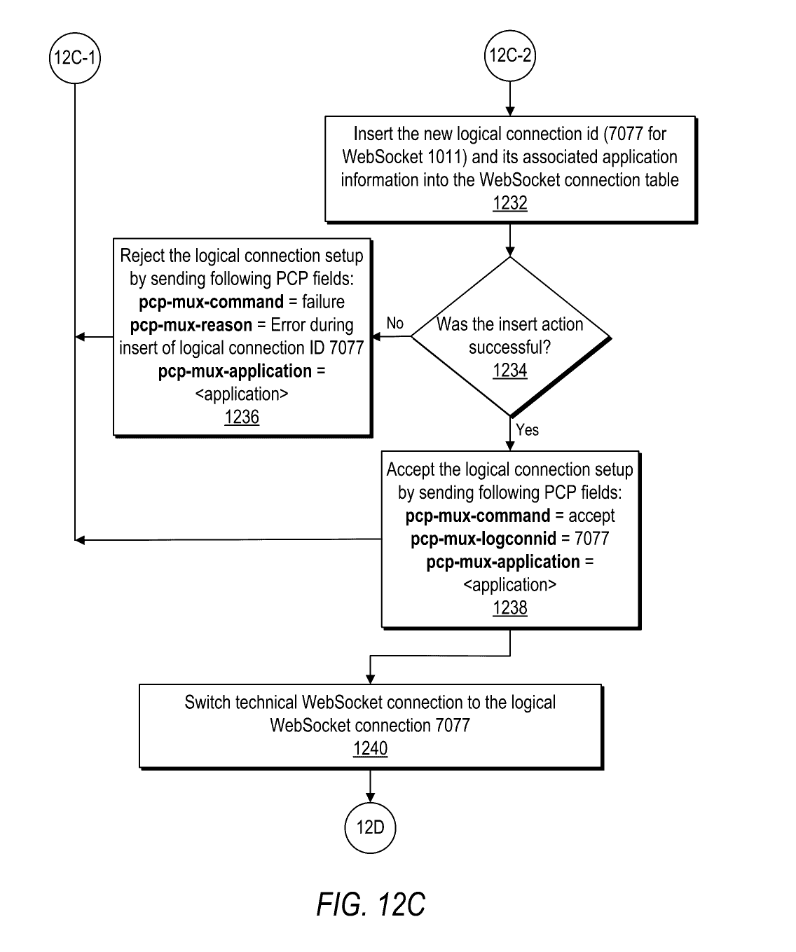

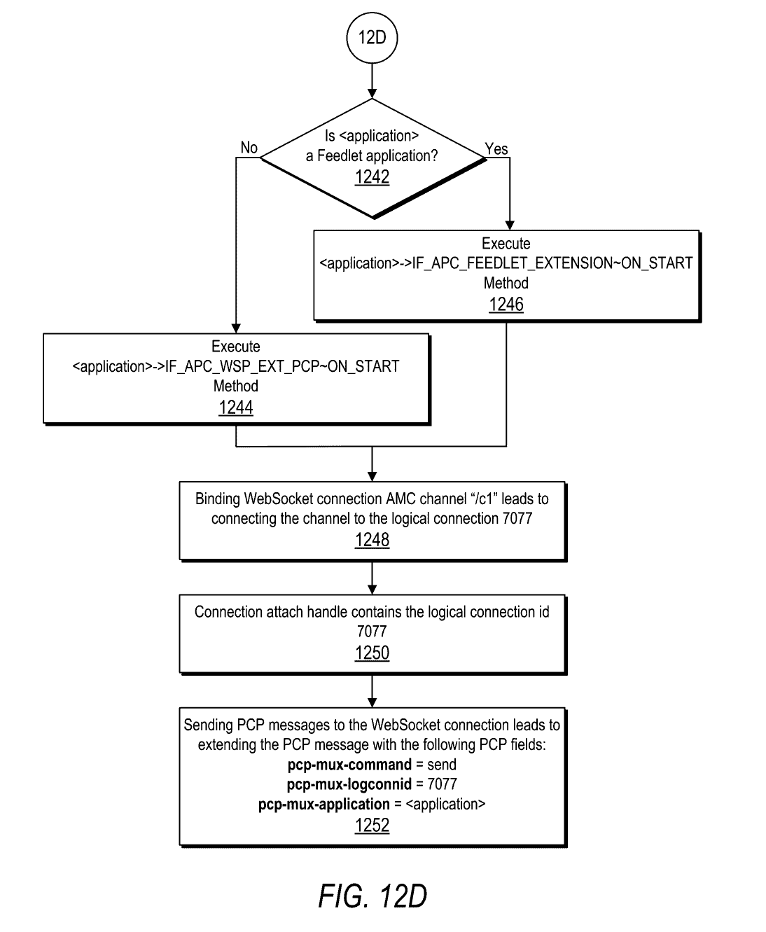

FIGS. 12A-12D illustrate a process flow 1200 for a logical WebSocket connection setup, in accordance with some example embodiments. Although specific steps, components, identifiers, and values are provided with respect to the operations of FIGS. 12A-12D, it is contemplated that modifications to these details are also within the scope of the present disclosure.

At operation 1202, the <PCP MUX>@UI5 (e.g., a component dispatcher 330) performs a setup of the technical WebSocket connection 7077 for URL “<URL>” by sending the PCP fields:
pcp-mux-command=open
pcp-mux-logconnid=7077
pcp-mux-url=<URL>

At operation 1204, the <PCP MUX>@ABAP (e.g., the feed services module 310) determines the PCP field “pcp-mux-command.” At operation 1206, it is determined if the determined PCP field “pcp-mux-command” is equal to “open.” If it is determined that the determined PCP field “pcp-mux-command” is equal to “open”, then it is determined, at operation 1208, whether or not the PCP fields “pcp-mux-logconnid” and “pcp-mux-url” are available. If it is determined that they are not available, then the logical connection setup is rejected, at operation 1210, by sending the following PCP fields:
pcp-mux-command=failure
pcp-mux-reason=protocol violation

If it is determined that the PCP fields “pcp-mux-logconnid” and “pcp-mux-url” are available, then the application <application> is determined at operation 1212. At operation 1216, it is determined if the application <application> exists. If it is determined that the application <application> does not exist, then the logical connection setup is rejected, at operation 1218, by sending the following PCP fields:
pcp-mux-command=reject
pcp-mux-reason=application <application> does not exist
pcp-mux-logconnid=7077
pcp-mux-url=<URL>

If it is determined that the application <application> does exist, then an HTTP object is created, at operation 1220, according to <URL> information and a context object for the next processing steps. At operation 1222, it is determined if the <application> is a feedlet application. If it is determined that the <application> is not a feedlet application, then an <application> IF_APC_WSP_EXT_PCP˜ON_ACCEPT method is executed at operation 1224. If it is determined that the <application> is a feedlet application, then an <application> IF_APC_FEEDLET EXTENSION˜ON_ACCEPT method is executed at operation 1226.

At operation 1228, it is determined whether or not the application accepts the connection setup. If it is determined that the application does not accept the connection setup, then the logical connection setup is rejected, at operation 1230, by sending the following PCP fields:
pcp-mux-command=reject
pcp-mux-reason=application <application> rejected the
connection setup
pcp-mux-logconnid=7077
pcp-mux-url=<URL>

If it is determined that the application does accept the connection setup, then the new logical connection ID and its associated application information is inserted into the WebSocket connection table at operation 1232. At operation 1234, it is determined whether or not the insert action was successful. If it is determined that the insert action was not successful, then the logical connection setup is rejected, at operation 1236, by sending the following PCP fields:
pcp-mux-command failure
pcp-mux-reason=Error during insert of ogical connection ID 7077
pcp-mux-application=<application>

If it is determined that the insert action was successful, then the logical connection setup is accepted, at operation 1238, by sending the following PCP fields:
pcp-mux-command=accept
pcp-mux-logconnid=7077
pcp-mux-application=<application>

At operation 1240, the technical WebSocket connection is switched to the logical WebScoket connection 7077. At operation 1242, it is determined whether or not <application> is a feedlet application. If it is determined that <application> is not a feedlet application, then an <application>->IF_APC_WSP_EXT_PCP˜ON_START method is executed at operation 1244. If it is determined that <application> is a feedlet application, then an <application>->IF_APC_FEEDLET EXTENSION˜ON_START method is executed at operation 1246. At operation 1248, binding WebSocket connection AMC channel “/c1” leads to connecting the channel to the logical connection 7077. At operation 1250, the connection attach handle contains the logical connection ID. At operation 1252, PCP messages are sent to the WebSocket connection leads to extend the PCP message with the following PCP fields:
pcp-mux-command=send
pcp-mux-logconnid=7077
pcp-mux-application=<application>

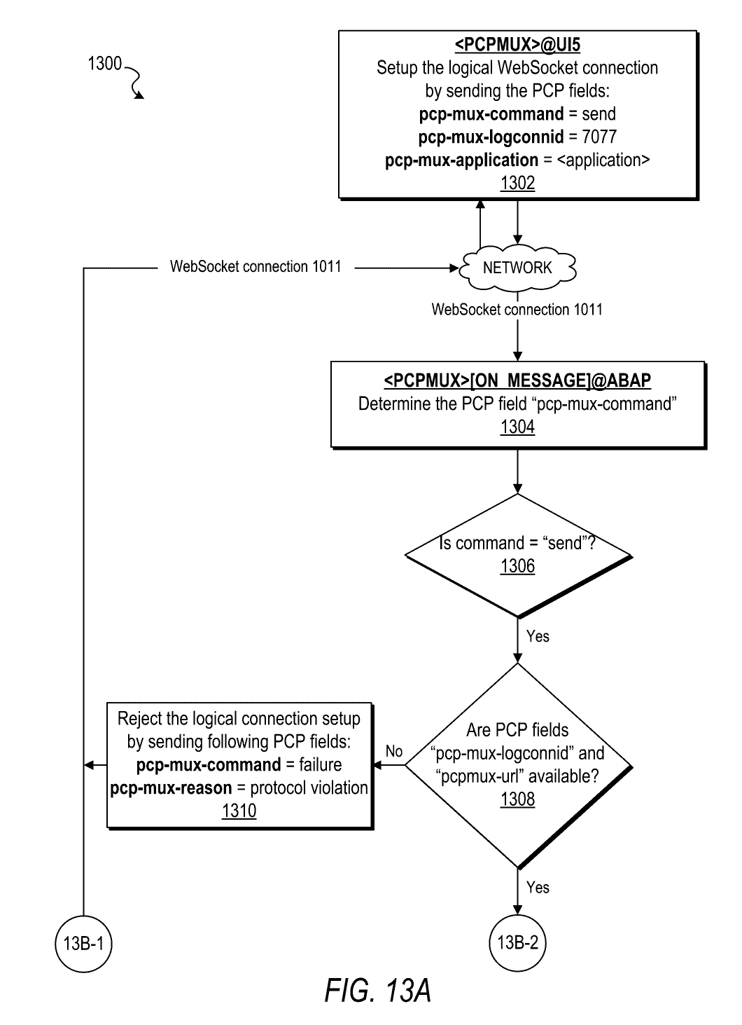

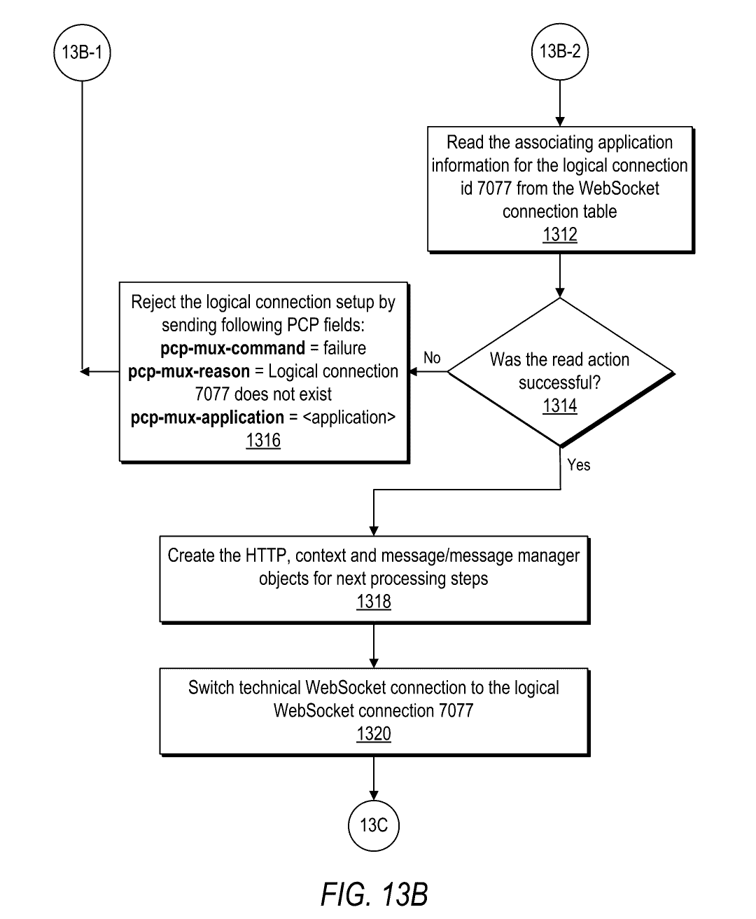

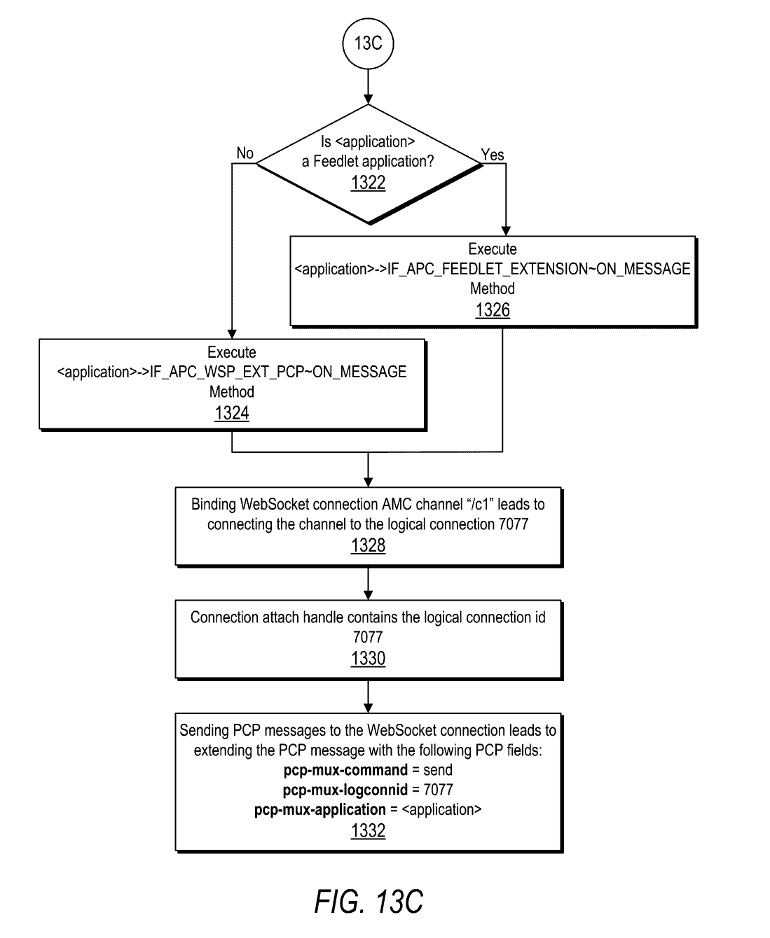

FIGS. 13A-13C illustrate a process flow for handling of a WebSocket send on a logical WebSocket connection, in accordance with some example embodiments. Although specific steps, components, identifiers, and values are provided with respect to the operations of FIGS. 13A-13C, it is contemplated that modifications to these details are also within the scope of the present disclosure.

At operation 1302, the <PCP MUX>@UI5 (e.g., a component dispatcher 330) performs a setup of the logical WebSocket connection by sending the PCP fields:
pcp-mux-command=send
pcp-mux-logconnid=7077
pcp-mux-application=<application>

At operation 1304, the <PCP MUX>@ABAP (e.g., the feed services module 310) determines the PCP field “pcp-mux-command.” At operation 1306, it is determined whether or not the command is equal to “send.” If it is determined that the command is equal to “send,” then it is determined whether or not the PCP fields “pcp-mux-logconnid” and “pcp-mux-url” are available at operation 1308. If it is determined that the PCP fields “pcp-mux-logconnid” and “pcp-mux-url” are not available, then the logical connection setup is rejected, at operation 1310, by sending the following PCP fields:
pcp-mux-command=failure
pcp-mux-reason=protocol violation

If it is determined that the PCP fields “pcp-mux-logconnid” and “pcp-mux-url” are available, then the associating application information for the logical connection ID 7077 is read from the WebSocket connection table at operation 1312. At operation 1314, it is determined if the read action was successful. If it is determined that the read action was not successful, then the logical connection setup is rejected, at operation 1316, by sending the following PCP fields:
pcp-mux-command=failure
pcp-mux-reason=Logical connection 7077 does not exist
pcp-mux-application=<application>

If it is determined that the read action was successful, then the HTTP, context, and message/message manager objects are created, at operation 1318, for the next processing steps. At operation 1320, the technical WebSocket connection is switched to the logical WebSocket connection 7077. At operation 1322, it is determined whether or not <application> is a feedlet application. If it is determined that <application> is not a feedlet application, then an <application>->IF_APC_WSP_EXT_PCP˜ON_MESSAGE method is executed at operation 1324. If it is determined that <application> is a feedlet application, then an <application>->IF_APC_FEEDLET EXTENSION˜ON_MESSAGE method is executed at operation 1326. At operation 1328, binding WebSocket connection AMC channel “/c1” leads to connecting the channel to the logical connection 7077. At operation 1330, the connection attach handle contains the logical connection ID. At operation 1332, sending PCP messages to the WebSocket connection leads to extending the PCP message with the following PCP fields:
pcp-mux-command=send
pcp-mux-logconnid=7077
pcp-mux-application=<application>

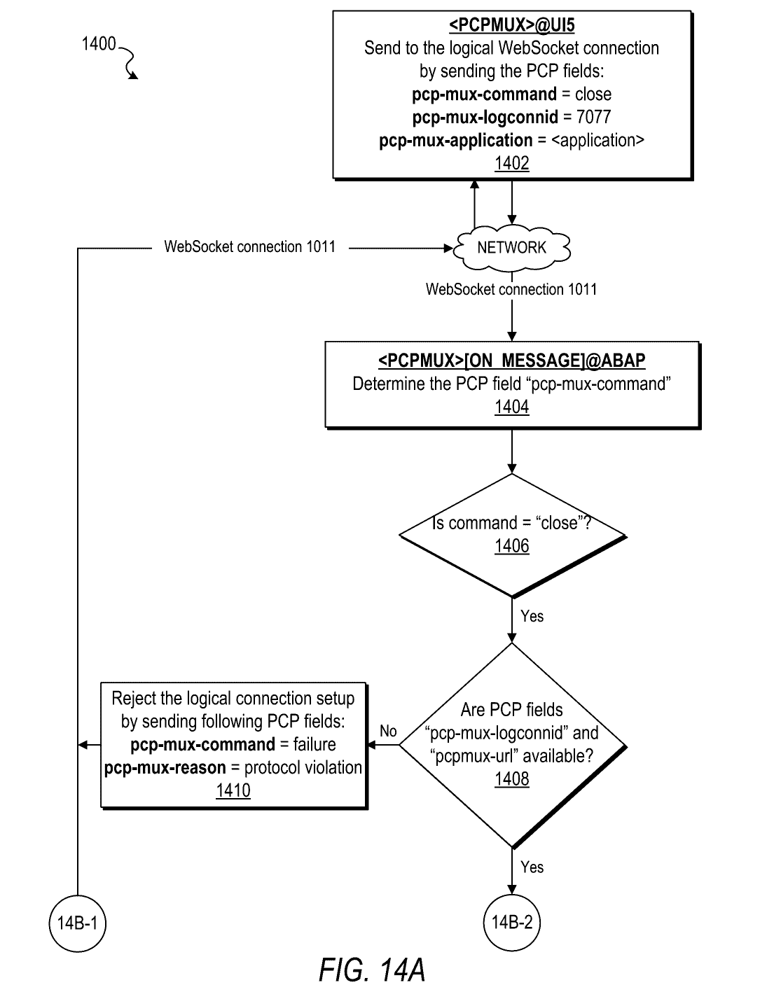

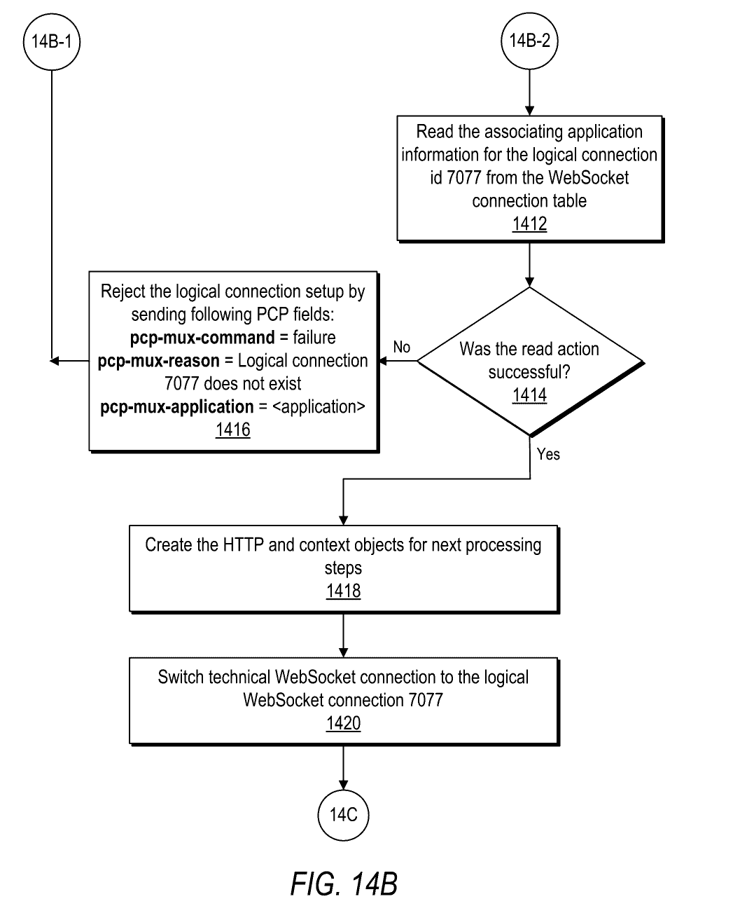

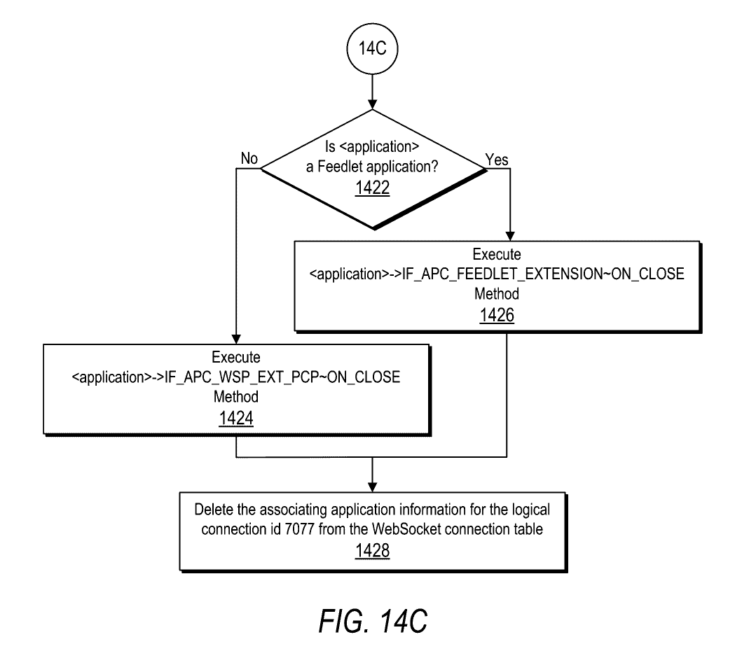

FIGS. 14A-14C illustrate a process flow for handling of a WebSocket close for a logical WebSocket connection, in accordance with some example embodiments. Although specific steps, components, identifiers, and values are provided with respect to the operations of FIGS. 14A-14C, it is contemplated that modifications to these details are also within the scope of the present disclosure.

At operation 1402, the <PCP MUX>@UI5 (e.g., a component dispatcher 330) sends a command to the logical WebSocket connection by sending the PCP fields:
pcp-mux-command=close
pcp-mux-logconnid=7077
pcp-mux-application=<application>

At operation 1404, the <PCP MUX>@ABAP (e.g., the feed services module 310) determines the PCP field “pcp-mux-command.” At operation 1406, it is determined whether or not the command is equal to “close.” If it is determined that the command is equal to “close,” then it is determined whether or not the PCP fields “pcp-mux-logconnid” and “pcp-mux-url” are available at operation 1408. If it is determined that the PCP fields “pcp-mux-logconnid” and “pcp-mux-url” are not available, then the logical connection setup is rejected, at operation 1410, by sending the following PCP fields:
pcp-mux-command=failure
pcp-mux-reason=protocol violation

If it is determined that the PCP fields “pcp-mux-logconnid” and “pcp-mux-url” are available, then the associating application information for the logical connection ID 7077 is read from the WebSocket connection table at operation 1412. At operation 1414, it is determined if the read action was successful. If it is determined that the read action was not successful, then the logical connection setup is rejected, at operation 1416, by sending the following PCP fields:
pcp-mux-command=failure
pcp-mux-reason=Logical connection 7077 does not exist
pcp-mux-application=<application>

If it is determined that the read action was successful, then the HTTP and context objects are created, at operation 1418, for the next processing steps. At operation 1420, the technical WebSocket connection is switched to the logical WebSocket connection 7077. At operation 1422, it is determined whether or not <application> is a feedlet application. If it is determined that <application> is not a feedlet application, then an <application>-> IF_APC_WSP_EXT_PCP˜ON_CLOSE method is executed at operation 1424. If it is determined that <application> is a feedlet application, then an <application>->IF_APC_FEEDLET EXTENSION˜ON_CLOSE method is executed at operation 1426. At operation 1428, the associating application information for the logical connection ID 7077 is deleted from the WebSocket connection table.

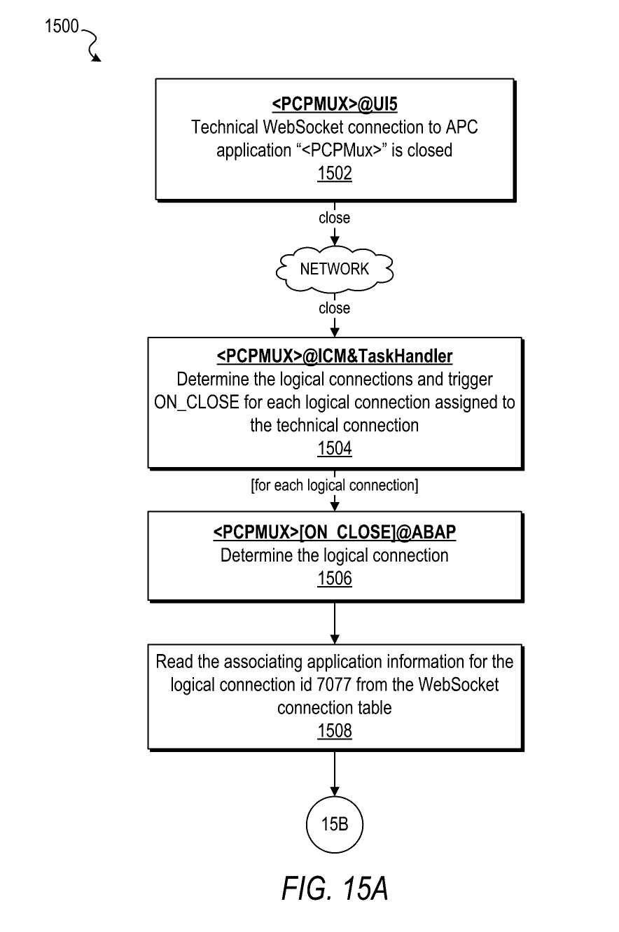

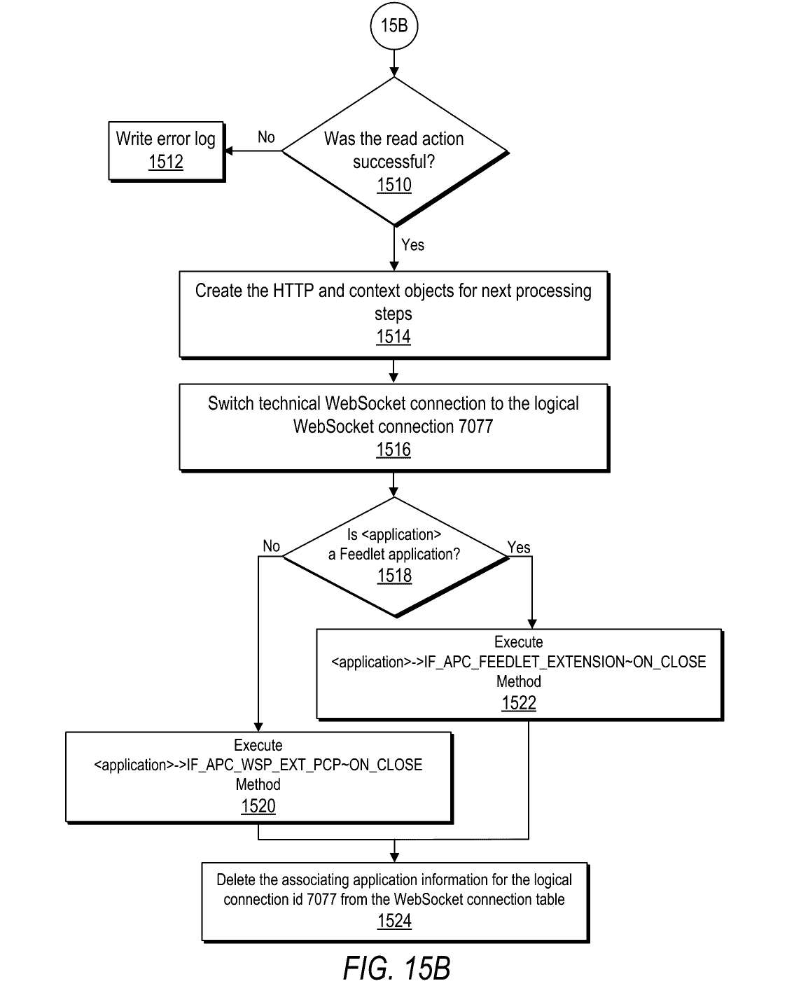

FIGS. 15A-15B illustrate a process flow for handling of a WebSocket close for a technical WebSocket connection, in accordance with some example embodiments. Although specific steps, components, identifiers, and values are provided with respect to the operations of FIGS. 15A-15B, it is contemplated that modifications to these details are also within the scope of the present disclosure.

At operation 1502, the <PCP MUX>@UI5 (e.g., a component dispatcher 330) closes the technical WebSocket connection to the APC application <PCP MUX>. At operation 1504, the ICM and Task Handler determine the logical connections and trigger ON_CLOSE for each logical connection assigned to the technical connection. At operation 1506, the <PCP MUX>@ABAP (e.g., the feed services module 310) determines the logical connection. At operation 1508, the associating application information for the logical connection ID 7077 is read from the WebSocket connection table.

At operation 1510, it is determined if the read action was successful. If it is determined that the read action was not successful, then a record of the unsuccessful action is written to an error log at operation 1512. If it is determined that the read action was successful, then the HTTP and context objects are created, at operation 1514, for the next processing steps. At operation 1516, the technical WebSocket connection is switched to the logical WebSocket connection 7077. At operation 1518, it is determined whether or not <application> is a feedlet application. If it is determined that <application> is not a feedlet application, then an <application>-> IF_APC_WSP_EXT_PCP˜ON_CLOSE method is executed at operation 1520. If it is determined that <application> is a feedlet application, then an <application>-> IF_APC_FEEDLET EXTENSION˜ON_CLOSE method is executed at operation 1522. At operation 1524, the associating application information for the logical connection ID 7077 is deleted from the WebSocket connection table.

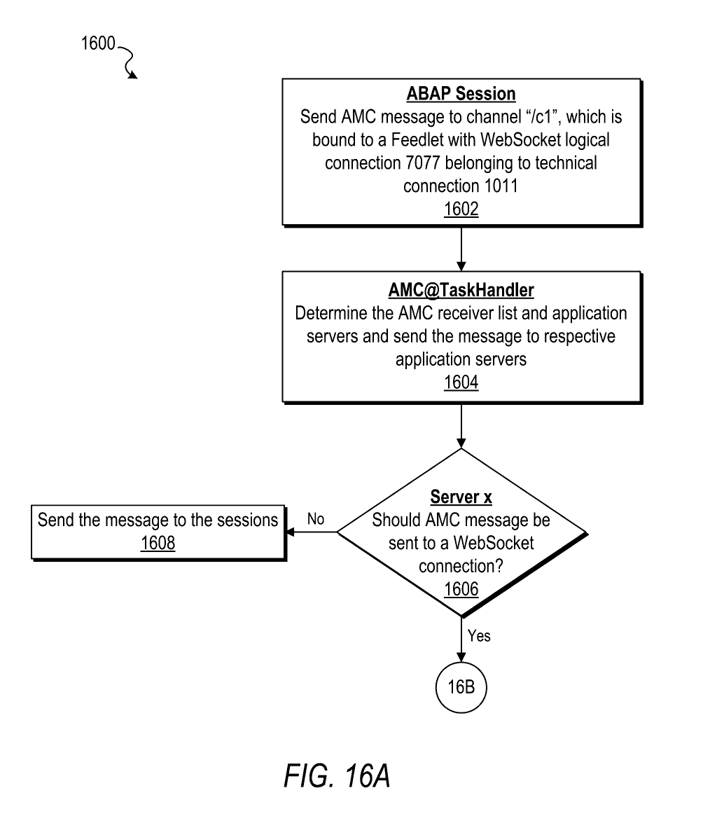

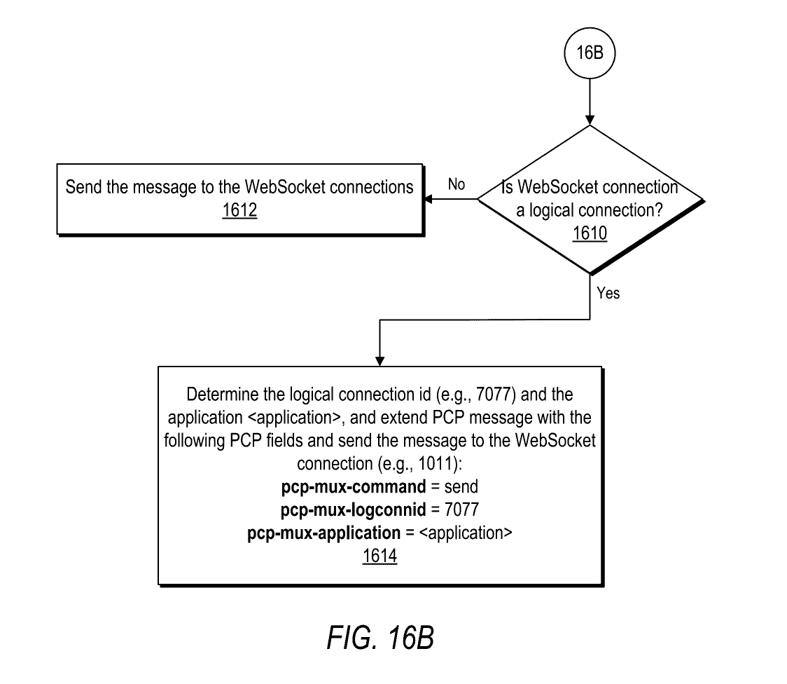

FIGS. 16A-16B illustrate a process flow for handling of an AMC send to a logical WebSocket connection, in accordance with some example embodiments. Although specific steps, components, identifiers, and values are provided with respect to the operations of FIGS. 16A-16B, it is contemplated that modifications to these details are also within the scope of the present disclosure.

At operation 1602, the ABAP session sends an AMC message to channel “/c1”, which is bound to a feedlet with the WebSocket logical connection 7077 belonging to technical connection 1011. At operation 1604, the AMC Task Handler determines the AMC receiver list and application servers, and sends the message to the respective application servers. At operation 1606, the server determines if the AMC message should be sent to a WebSocket connection. If it is determined that the AMC message should not be sent to a WebSocket connection, then the message is send to the sessions at operation 1608. If it is determined that the AMC message should be sent to a WebSocket connection, then it is determined if the WebSocket connection is a logical connection at operation 1610. If it is determined that the WebSocket connection is not a logical connection, then the message is sent to the WebSocket connection at operation 1612. If it is determined that the WebSocket connection is a logical connection, then the logical connection ID and the application <application> are determined, at operation 1614, and the PCP message is extended with the following PCP fields and the message is sent to the WebSocket connection:
pcp-mux-command=send
pcp-mux-logconnid=7077
pcp-mux-application=<application

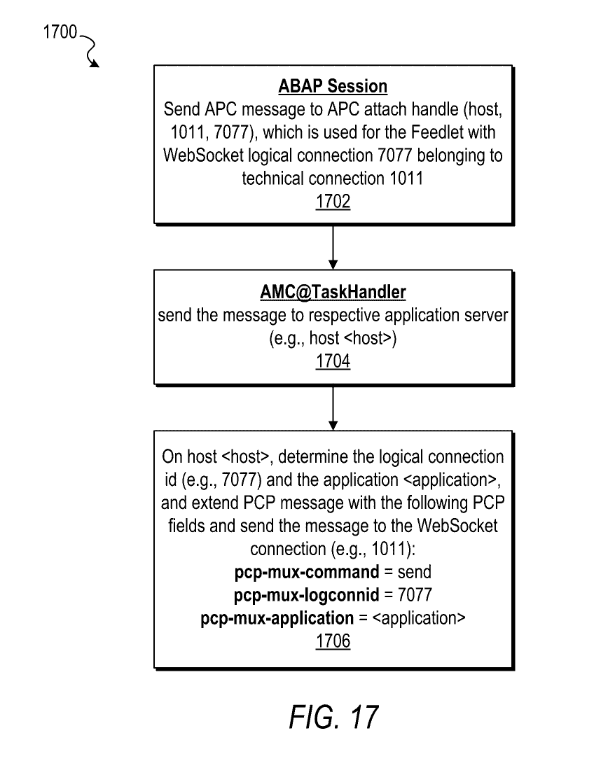

FIG. 17 illustrates a process flow for handling of an APC send based on an APC attach handle to a logical WebSocket connection, in accordance with some example embodiments. Although specific steps, components, identifiers, and values are provided with respect to the operations of FIG. 17, it is contemplated that modifications to these details are also within the scope of the present disclosure.

At operation 1702, the ABAP session sends an APC message to an APC attach handle, which is used for the feedlet with WebSocket logical connection 7077 belonging to technical connection 1011. At operation 1704, the AMC Task Handler sends the message to the respective application server. At operation 1706, on the respective application server (e.g., host <host>), the logical connection ID and the application <application> are determined, and the PCP message is extended with the following PCP fields, and the message is sent to the WebSocket connection:
pcp-mux-command=send
pcp-mux-logconnid=7077
pcp-mux-application=<application>

It is contemplated that any features of any embodiments disclosed herein can be combined with any other features of any other embodiments disclosed herein. Accordingly, these any such hybrid embodiments are within the scope of the present disclosure.

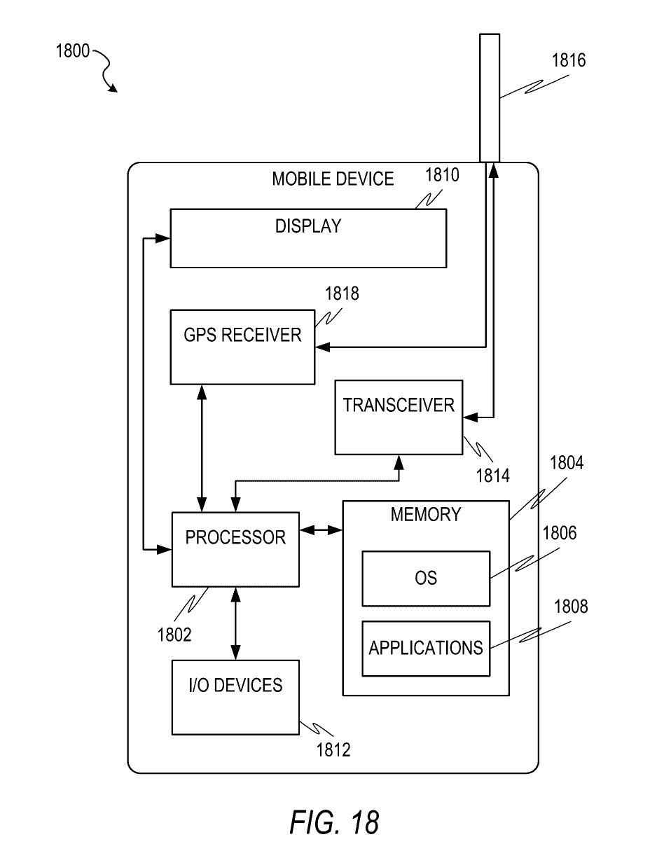

FIG. 18 is a block diagram illustrating a mobile device 1800, in accordance with some example embodiments. The mobile device 1800 can include a processor 1802. The processor 1802 can be any of a variety of different types of commercially available processors suitable for mobile devices 1800 (for example, an XScale architecture microprocessor, a Microprocessor without Interlocked Pipeline Stages (MIPS) architecture processor, or another type of processor). A memory 1804, such as a random access memory (RAM), a Flash memory, or other type of memory, is typically accessible to the processor 1802. The memory 1804 can be adapted to store an operating system (OS) 1806, as well as application programs 1808, such as a mobile location enabled application that can provide LBSs to a user. The processor 1802 can be coupled, either directly or via appropriate intermediary hardware, to a display 1810 and to one or more input/output (I/O) devices 1812, such as a keypad, a touch panel sensor, a microphone, and the like. Similarly, in some example embodiments, the processor 1802 can be coupled to a transceiver 1814 that interfaces with an antenna 1816. The transceiver 1814 can be configured to both transmit and receive cellular network signals, wireless data signals, or other types of signals via the antenna 1816, depending on the nature of the mobile device 1800. Further, in some configurations, a GPS receiver 1818 can also make use of the antenna 1816 to receive GPS signals.

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client, or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the network 104 of FIG. 1) and via one or more appropriate interfaces (e.g., APIs).

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., a FPGA or an ASIC).

A computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

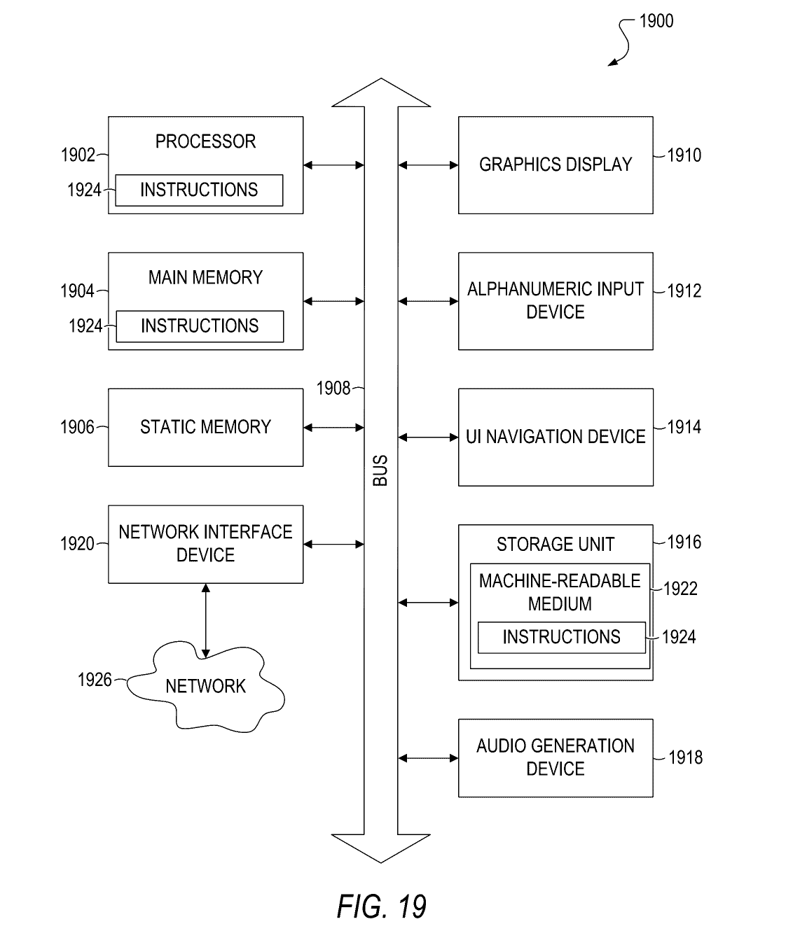

FIG. 19 is a block diagram of a machine in the example form of a computer system 1900 within which instructions for causing the machine to perform any one or more of the methodologies discussed herein may be executed. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1900 includes a processor 1902 (e.g., a central processing unit (CPU), a graphics processing unit (GPU) or both), a main memory 1904 and a static memory 1906, which communicate with each other via a bus 1908. The computer system 1900 may further include a graphics or video display unit 1910 (e.g., a liquid crystal display (LCD) or a cathode ray tube (CRT)). The computer system 1900 also includes an alphanumeric input device 1912 (e.g., a keyboard), a user interface (UI) navigation (or cursor control) device 1914 (e.g., a mouse), a storage unit (e.g., a disk drive unit) 1916, an audio or signal generation device 1918 (e.g., a speaker), and a network interface device 1920.

The storage unit 1916 includes a machine-readable medium 1922 on which is stored one or more sets of data structures and instructions 1924 (e.g., software) embodying or utilized by any one or more of the methodologies or functions described herein. The instructions 1924 may also reside, completely or at least partially, within the main memory 1904 and/or within the processor 1902 during execution thereof by the computer system 1900, the main memory 1904 and the processor 1902 also constituting machine-readable media. The instructions 1924 may also reside, completely or at least partially, within the static memory 1906.

While the machine-readable medium 1922 is shown in an example embodiment to be a single medium, the term “machine-readable medium” may include a single medium or multiple media (e.g., a centralized or distributed database, and/or associated caches and servers) that store the one or more instructions 1924 or data structures. The term “machine-readable medium” shall also be taken to include any tangible medium that is capable of storing, encoding or carrying instructions for execution by the machine and that cause the machine to perform any one or more of the methodologies of the present embodiments, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices (e.g., Erasable Programmable Read-Only Memory (EPROM), Electrically Erasable Programmable Read-Only Memory (EEPROM), and flash memory devices); magnetic disks such as internal hard disks and removable disks; magneto-optical disks; and compact disc-read-only memory (CD-ROM) and digital versatile disc (or digital video disc) read-only memory (DVD-ROM) disks.

The instructions 1924 may further be transmitted or received over a communications network 1926 using a transmission medium. The instructions 1924 may be transmitted using the network interface device 1920 and any one of a number of well-known transfer protocols (e.g., HTTP). Examples of communication networks include a LAN, a WAN, the Internet, mobile telephone networks, POTS networks, and wireless data networks (e.g., WiFi and WiMax networks). The term “transmission medium” shall be taken to include any intangible medium capable of storing, encoding, or carrying instructions for execution by the machine, and includes digital or analog communications signals or other intangible media to facilitate communication of such software.

Each of the features and teachings disclosed herein can be utilized separately or in conjunction with other features and teachings to provide a system and method for selective gesture interaction using spatial volumes. Representative examples utilizing many of these additional features and teachings, both separately and in combination, are described in further detail with reference to the attached figures. This detailed description is merely intended to teach a person of skill in the art further details for practicing preferred aspects of the present teachings and is not intended to limit the scope of the claims. Therefore, combinations of features disclosed above in the detailed description may not be necessary to practice the teachings in the broadest sense, and are instead taught merely to describe particularly representative examples of the present teachings.

Some portions of the detailed descriptions herein are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the below discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present disclosure also relates to an apparatus for performing the operations herein. This apparatus may be specially constructed for the required purposes, or it may include a general purpose computer selectively activated or reconfigured by a computer program stored in the computer. Such a computer program may be stored in a computer readable storage medium, such as, but is not limited to, any type of disk, including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The example methods or algorithms presented herein are not inherently related to any particular computer or other apparatus. Various general purpose systems, computer servers, or personal computers may be used with programs in accordance with the teachings herein, or it may prove convenient to construct a more specialized apparatus to perform the required method steps. The required structure for a variety of these systems will appear from the description below. It will be appreciated that a variety of programming languages may be used to implement the teachings of the disclosure as described herein.

Moreover, the various features of the representative examples and the dependent claims may be combined in ways that are not specifically and explicitly enumerated in order to provide additional useful embodiments of the present teachings. It is also expressly noted that all value ranges or indications of groups of entities disclose every possible intermediate value or intermediate entity for the purpose of original disclosure, as well as for the purpose of restricting the claimed subject matter. It is also expressly noted that the dimensions and the shapes of the components shown in the figures are designed to help to understand how the present teachings are practiced, but not intended to limit the dimensions and the shapes shown in the examples.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

1. A system comprising:
at least one processor; and
a non-transitory computer-readable medium storing executable instructions that, when executed, cause the at least one processor to perform operations comprising:
receiving first feed data from a first feed source;
generating a first message based on the first feed data and a messaging protocol, the first message comprising the first feed data and first context information, the first context information being generated according to the messaging protocol and indicating a first application on a first computing device;
transmitting the first message to a first component dispatcher on the first computing device via a first WebSocket connection, the first component dispatcher being configured to transmit the first feed data to the first application based on the first context information;
receiving second feed data from a second feed source;
generating a second message based on the second feed data and the messaging protocol, the second message comprising the second feed data and second context information, the second context information being generated according to the messaging protocol and indicating the first application on the first computing device; and
transmitting the second message to the first component dispatcher via the first WebSocket connection, the first component dispatcher being configured to transmit the second feed data to the first application based on the second context information.

2. The system of claim 1, wherein the operations further comprise:
generating a third message based on the first feed data and the messaging protocol, the third message comprising the first feed data and third context information, the third context information being generated according to the messaging protocol and indicating a second application on a second computing device; and
transmitting the third message to a second component dispatcher on the second computing device via a second WebSocket connection, the second component dispatcher being configured to transmit the first feed data of the third message to the second application on the second computing device based on the third context information.

3. The system of claim 1, wherein the operations further comprise:
generating a fourth message based on the first feed data and the messaging protocol, the fourth message comprising the first feed data and fourth context information, the fourth context information being generated according to the messaging protocol and indicating a third application on the first computing device; and
transmitting the fourth message to the first component dispatcher on the first computing device via the first WebSocket connection, the first component dispatcher being configured to transmit the first feed data of the fourth message to the third application on the first computing device based on the fourth context information.

4. The system of claim 1, wherein the operations further comprise:
receiving third feed data from the first feed source;
generating a fifth message based on the third feed data and the messaging protocol, the fifth message comprising the third feed data and fifth context information, the fifth context information being generated according to the messaging protocol and indicating the first application on the first computing device; and
transmitting the fifth message to the first component dispatcher on the first computing device via the first WebSocket connection, the first component dispatcher being configured to transmit the third feed data of the fifth message to the first application on the first computing device based on the fifth context information.

5. The system of claim 1, wherein the first message and the second message each being without a Hypertext Transfer Protocol (HTTP) start-line.

6. The system of claim 1, wherein the WebSocket connection comprises an Advanced Business Application Programming (ABAP) push channel connection.

7. The system of claim 1, wherein:
the first context information indicates a first user interface area of the first application corresponding to a first business object, the first feed data being used to update the first user interface area of the first application; and
the second context information indicates a second user interface area of the first application corresponding to a second business object, the second feed data being used to update the second user interface area of the first application.

8. A computer-implemented method comprising:
receiving first feed data from a first feed source;
generating, by a machine having a memory and at least one processor, a first message based on the first feed data and a messaging protocol, the first message comprising the first feed data and first context information, the first context information being generated according to the messaging protocol and indicating a first application on a first computing device;
transmitting the first message to a first component dispatcher on the first computing device via a first WebSocket connection, the first component dispatcher being configured to transmit the first feed data to the first application based on the first context information;
receiving second feed data from a second feed source;
generating a second message based on the second feed data and the messaging protocol, the second message comprising the second feed data and second context information, the second context information being generated according to the messaging protocol and indicating the first application on the first computing device; and
transmitting the second message to the first component dispatcher via the first WebSocket connection, the first component dispatcher being configured to transmit the second feed data to the first application based on the second context information.

9. The computer-implemented method of claim 8, further comprising:
generating a third message based on the first feed data and the messaging protocol, the third message comprising the first feed data and third context information, the third context information being generated according to the messaging protocol and indicating a second application on a second computing device; and
transmitting the third message to a second component dispatcher on the second computing device via a second WebSocket connection, the second component dispatcher being configured to transmit the first feed data of the third message to the second application on the second computing device based on the third context information.

10. The computer-implemented method of claim 8, further comprising:
generating a fourth message based on the first feed data and the messaging protocol, the fourth message comprising the first feed data and fourth context information, the fourth context information being generated according to the messaging protocol and indicating a third application on the first computing device; and
transmitting the fourth message to the first component dispatcher on the first computing device via the first WebSocket connection, the first component dispatcher being configured to transmit the first feed data of the fourth message to the third application on the first computing device based on the fourth context information.

11. The computer-implemented method of claim 8, further comprising:
receiving third feed data from the first feed source;
generating a fifth message based on the third feed data and the messaging protocol, the fifth message comprising the third feed data and fifth context information, the fifth context information being generated according to the messaging protocol and indicating the first application on the first computing device; and
transmitting the fifth message to the first component dispatcher on the first computing device via the first WebSocket connection, the first component dispatcher being configured to transmit the third feed data of the fifth message to the first application on the first computing device based on the fifth context information.

12. The computer-implemented method of claim 8, wherein the first message and the second message each being without a Hypertext Transfer Protocol (HTTP) start-line.

13. The computer-implemented method of claim 8, wherein the WebSocket connection comprises an Advanced Business Application Programming (ABAP) push channel connection.

14. The computer-implemented method of claim 8, wherein:
the first context information indicates a first user interface area of the first application corresponding to a first business object, the first feed data being used to update the first user interface area of the first application; and
the second context information indicates a second user interface area of the first application corresponding to a second business object, the second feed data being used to update the second user interface area of the first application.

15. A non-transitory machine-readable storage medium, tangibly embodying a set of instructions that, when executed by at least one processor, causes the at least one processor to perform operations comprising:
receiving first feed data from a first feed source;
generating a first message based on the first feed data and a messaging protocol, the first message comprising the first feed data and first context information, the first context information being generated according to the messaging protocol and indicating a first application on a first computing device;
transmitting the first message to a first component dispatcher on the first computing device via a first WebSocket connection, the first component dispatcher being configured to transmit the first feed data to the first application based on the first context information;
receiving second feed data from a second feed source;
generating a second message based on the second feed data and the messaging protocol, the second message comprising the second feed data and second context information, the second context information being generated according to the messaging protocol and indicating the first application on the first computing device; and
transmitting the second message to the first component dispatcher via the first WebSocket connection, the first component dispatcher being configured to transmit the second feed data to the first application based on the second context information.

16. The non-transitory machine-readable storage medium of claim 15, wherein the operations further comprise:
generating a third message based on the first feed data and the messaging protocol, the third message comprising the first feed data and third context information, the third context information being generated according to the messaging protocol and indicating a second application on a second computing device; and
transmitting the third message to a second component dispatcher on the second computing device via a second WebSocket connection, the second component dispatcher being configured to transmit the first feed data of the third message to the second application on the second computing device based on the third context information.

17. The non-transitory machine-readable storage medium of claim 15, wherein the operations further comprise:
generating a fourth message based on the first feed data and the messaging protocol, the fourth message comprising the first feed data and fourth context information, the fourth context information being generated according to the messaging protocol and indicating a third application on the first computing device; and
transmitting the fourth message to the first component dispatcher on the first computing device via the first WebSocket connection, the first component dispatcher being configured to transmit the first feed data of the fourth message to the third application on the first computing device based on the fourth context information.

18. The non-transitory machine-readable storage medium of claim 15, wherein the operations further comprise:
receiving third feed data from the first feed source;
generating a fifth message based on the third feed data and the messaging protocol, the fifth message comprising the third feed data and fifth context information, the fifth context information being generated according to the messaging protocol and indicating the first application on the first computing device; and
transmitting the fifth message to the first component dispatcher on the first computing device via the first WebSocket connection, the first component dispatcher being configured to transmit the third feed data of the fifth message to the first application on the first computing device based on the fifth context information.

19. The non-transitory machine-readable storage medium of claim 15, wherein the first message and the second message each being without a Hypertext Transfer Protocol (HTTP) start-line.

20. The non-transitory machine-readable storage medium of claim 15, wherein:
the first context information indicates a first user interface area of the first application corresponding to a first business object, the first feed data being used to update the first user interface area of the first application; and
the second context information indicates a second user interface area of the first application corresponding to a second business object, the second feed data being used to update the second user interface area of the first application.
